(19) United States
(12) Patent Application Publication
(10) Pub. No.: US 2022/0063054 A1
(43) Pub. Date: Mar. 3, 2022

(54) POWER TOOL

(71) Applicant: Nanjing Chervon Industry Co., Ltd., Nanjing (CN)

(72) Inventors: Xiangqing Fu, Nanjing (CN); Jingdong Hao, Nanjing (CN); Liang Chen, Nanjing (CN); Shuming Wu, Nanjing (CN)

(21) Appl. No.: 17/522,681

(22) Filed: Nov. 9, 2021

Related U.S. Application Data
(63) Continuation of application No. PCT/CN2020/092571, filed on May 27, 2020.

(30) Foreign Application Priority Data
May 29, 2019 (CN) 201910454858.8
Jun. 28, 2019 (CN) 201910571661.2
Dec. 30, 2019 (CN) 201911388984.4

(51) Int. Cl. B24B 45/00; B24B 23/02; B25F 1/02

(52) U.S. Cl. CPC B24B 45/006; B25F 1/02; B24B 23/022

(57) ABSTRACT

A power tool includes an output shaft, an installation apparatus and a retention mechanism. The installation apparatus has an operation state and an installation state. The retention mechanism is capable of providing a retaining force that keeps the installation apparatus in the installation state. The retention mechanism includes a movable piece. The output shaft is formed with a guide rail that guides the movable piece to move. The movable piece is capable of moving along the guide rail to a first retention position and a second retention position. When the installation apparatus is in the installation state and receives a rotation force applied by the operation accessory, the rotation force causes the movable piece to move from the second retention position to the first retention position so that the installation apparatus is switched from the installation state to the operation state.

### RELATED APPLICATION INFORMATION

This application claims the benefit under 35 U.S.C. § 119(a) of Chinese Patent Application No. 201910454858.8, filed on May. 29, 2019, Chinese Patent Application No. 201910571661.2, filed on Jun. 28, 2019, and Chinese Patent Application No. 201911388984.4, filed on Dec. 30, 2019, which are incorporated herein by reference in their entirety.

### TECHNICAL FIELD

The present application relates to a power device, for example, a power tool.

### BACKGROUND

Among some power tools that need to be installed with operation accessories, for example, an angle grinder is configured to cut a material or polish a workpiece. In a process of using the angle grinder, different types of grinding discs may need to be replaced due to frequent replacement and switching of operation conditions, or the grinding discs are worn out by the workpiece in an operation process of the angle grinder so that the grinding discs are consumed relatively greatly and thus need to be replaced more frequently.

In a traditional power tool, a shaft lock for locking a main shaft needs to be disposed in the power tool for installation and disassembly of the operation accessories. In addition, an auxiliary tool such as a wrench is needed to achieve installation and disassembly of the grinding discs. In this manner, a user needs to operate with two hands, which is troublesome and wastes energy; and the additional auxiliary tool such as the wrench is needed, which is troublesome and laborious. In the traditional power tool, a quick clamping structure exists so that the operation accessories can be installed without the aid of tools. However, to ensure the accuracy of clamping, the quick clamping structure is relatively complicated, which reduces the portability of the machine.

### SUMMARY

In one example of the disclosure, a power tool includes an output shaft and an installation apparatus. The output shaft is capable of rotating or swinging around a first axis. The installation apparatus is configured to install an operation accessory to the power tool and has an operation state and an installation state. In the case where the installation apparatus is in the operation state, the installation apparatus is capable of driving the operation accessory to move together with the output shaft. In the case where the installation apparatus is in the installation state, the installation apparatus allows the operation accessory to be installed to the installation apparatus and allows the operation accessory to be disassembled from the installation apparatus. The power tool further includes an inner shaft and a retention mechanism. The inner shaft is disposed in the output shaft and connected to the installation apparatus. The retention mechanism is capable of at least providing a retaining force that keeps the installation apparatus in a state in which the operation accessory is allowed to be disassembled and installed. The retention mechanism includes a movable piece connected to the inner shaft. The output shaft is formed with a guide rail that guides the movable piece to move. The movable piece is capable of moving along the guide rail to a first retention position and a second retention position. In the case where the installation apparatus is in the installation state and receives a rotation force applied by the operation accessory, the rotation force causes the movable piece to move from the second retention position to the first retention position so that the installation apparatus is switched from the installation state to the operation state.

In one example of the disclosure, the installation apparatus includes a first installation piece and a second installation piece fitting with each other to fix the operation accessory; in a process of the installation apparatus being switched from the operation state to the installation state, the first installation piece and the second installation piece rotate relative to each other in a circumferential direction around the first axis.

In one example of the disclosure, when the movable piece moves from the first retention position to the second retention position, the first installation piece rotates in a first rotation direction relative to the second installation piece, and a distance between the first installation piece and the second installation piece increases; and when the movable piece moves from the second retention position to the first retention position, the first installation piece rotates in a second rotation direction relative to the second installation piece, and the distance between the first installation piece and the second installation piece decreases.

In one example of the disclosure, the power tool includes an operation piece for a user to operate to drive the first installation piece to be disengaged from the second installation piece, where the operation piece is connected to a top end of the inner shaft and operable to drive the inner shaft to be displaced so that the movable piece slides from the first retention position to the second retention position.

In one example of the disclosure, the guide rail includes a first guide rail and a second guide rail that are smoothly connected; when the movable piece slides from the first retention position to the second retention position, the movable piece slides from the first guide rail to the second guide rail in the guide rail and provides the retaining force that keeps the installation apparatus in the installation state in the second guide rail.

In one example of the disclosure, a height of a sliding trajectory of the movable piece in a vertical direction of the guide rail is less than or equal to a height of the guide rail in the vertical direction.

In one example of the disclosure, when the movable piece moves from the first retention position to the second retention position, the movable piece rotates circumferentially relative to an axis of the inner shaft by 1° to 45°.

In one example of the disclosure, a power tool includes an output shaft, a motor, and a casing. The output shaft is capable of rotating or swinging around a first axis. The motor is configured to drive the output shaft. The casing is configured to support the motor. The power tool further includes an installation apparatus configured to install an operation accessory to the power tool and connected to the output shaft. The installation apparatus includes a first installation piece formed with a first clamping portion and a second installation piece formed with a second clamping portion capable of fitting with the first clamping portion to clamp the operation accessory. The installation apparatus receives a rotation force applied by the operation accessory so that the first installation piece moves to a first position and a second position relative to the second installation piece. In the case where the first installation piece moves to the first position, the first clamping portion is disengaged from the second clamping portion in a direction of the first axis, and the installation apparatus allows the operation accessory to be installed to the installation apparatus and allows the operation accessory to be disassembled from the installation apparatus. In the case where the first installation piece moves to the second position, the first clamping portion at least partially overlaps with the second clamping portion in the direction of the first axis, and the installation apparatus is capable of driving the operation accessory to move together with the output shaft.

In one example of the disclosure, in the case where the first installation piece is at the second position, in a direction parallel to the first axis, a distance between the first clamping portion and the second clamping portion is greater than 0 mm and less than or equal to 3 mm.

In one example of the disclosure, the first clamping portion has a first clamping surface for being in contact with the operation accessory, and the second clamping portion has a second clamping surface for being in contact with the operation accessory; in the case where the first installation piece is at the second position, the first clamping portion and the second clamping portion closest to the first clamping portion are defined as a clamping assembly; and in the case where the first installation piece is at the first position, a minimum dimension between the first clamping surface and the second clamping surface in the clamping assembly in a circumferential direction around the first axis is greater than or equal to 6 mm.

In one example of the disclosure, the first installation piece further includes a supporting surface connected to the first clamping surface, the supporting surface is perpendicular to the first axis, the first clamping surface drives the operation accessory to rotate, and the supporting surface axially supports the operation accessory.

In one example of the disclosure, the first clamping portion has an L-shaped structure.

In one example of the disclosure, in a clamping plane parallel to the first axis and intersecting with the first clamping surface and the second clamping surface, the first clamping surface has a first line of intersection that intersects with the clamping plane, and the second clamping surface has a second line of intersection that intersects with the clamping plane; where a straight line where the first line of intersection is located obliquely intersects with a straight line where the second line of intersection is located.

In one example of the disclosure, the installation apparatus further includes an inner shaft disposed coaxially with the output shaft, the first installation piece is connected to the inner shaft, and the second installation piece is connected to the output shaft.

In one example of the disclosure, a power tool includes an output shaft and an installation apparatus. The output shaft is configured to output power. The installation apparatus is configured to install an operation accessory to the power tool. The installation apparatus has an operation state and an installation state. In the case where the installation apparatus is in the operation state, the installation apparatus is capable of driving the operation accessory to move together with the output shaft. In the case where the installation apparatus is in the installation state, the installation apparatus allows the operation accessory to be installed to the installation apparatus and allows the operation accessory to be disassembled from the installation apparatus. The power tool further includes an energy storage element storing a driving force for driving the installation apparatus to have a tendency to move toward the operation state. In the case where the installation apparatus is in the installation state and receives a rotation force applied by the operation accessory, the energy storage element exerts the driving force to drive the installation apparatus to move to the operation state.

In one example of the disclosure, the installation apparatus further includes an inner shaft indirectly connected to the output shaft, and the inner shaft rotates relative to the output shaft to trigger the energy storage element to exert the driving force to drive the installation apparatus to move to the operation state.

In one example of the disclosure, the power tool includes a retention mechanism including a movable piece connected to the inner shaft and a guide rail formed on the output shaft, and the movable piece is placed in the guide rail and capable of sliding in the guide rail so that the inner shaft and the output shaft are indirectly connected and capable of rotating relative to each other.

In one example of the disclosure, the output shaft is capable of rotating or swinging around a first axis; the output shaft is formed with a receiving cavity around the inner shaft, and the movable piece extends in a direction perpendicular to the first axis and is inserted into the guide rail in the direction perpendicular to the first axis.

In one example of the disclosure, the energy storage element is a spring disposed in the receiving cavity, and the spring is sleeved on the inner shaft and biases against the inner shaft to produce the driving force.

In one example of the disclosure, a power tool includes an output shaft and an installation apparatus. The output shaft is capable of rotating or swinging around a first axis. The installation apparatus is configured to install an operation accessory to the power tool and has an operation state and an installation state. In the case where the installation apparatus is in the operation state, the installation apparatus is capable of driving the operation accessory to move together with the output shaft. In the case where the installation apparatus is in the installation state, the installation apparatus allows the operation accessory to be installed to the installation apparatus and allows the operation accessory to be disassembled from the installation apparatus. The power tool further includes a retention mechanism capable of at least providing a retaining force that keeps the installation apparatus in the installation state. In the case where the installation apparatus is in the installation state and receives a rotation force applied by the operation accessory, the rotation force triggers the retention mechanism to release a retention effect on the installation apparatus, and the installation apparatus is switched from the installation state to the operation state.

In one example of the disclosure, the output shaft is capable of rotating or swinging around the first axis; the power tool further includes an inner shaft rotatable relative to the output shaft, where the inner shaft is connected to the installation apparatus, and the installation apparatus transmits the received rotation force to the inner shaft so that the inner shaft rotates relative to the output shaft to trigger the retention mechanism to release the retention effect on the installation apparatus.

In one example of the disclosure, the power tool is an angle grinder, and in the case where the installation apparatus is in the operation state, the output shaft is capable of driving the operation accessory to rotate around the first axis in a first rotation direction; the power tool further includes a limiting mechanism that prevents the output shaft from rotating around the first axis in a second rotation direction opposite to the first rotation direction.

In one example of the disclosure, the limiting mechanism includes a one-way bearing connected to the output shaft.

In one example of the disclosure, the power tool further includes a limiting mechanism capable of being switched between a state in which the output shaft is allowed to rotate and a state in which the output shaft is prevented from rotating.

In one example of the disclosure, the power tool further includes a limiting mechanism, where the limiting mechanism is connected to the inner shaft, meshes with the output shaft to allow the output shaft to rotate only in a direction opposite to a rotation direction of the inner shaft in the installation state, and is disengaged from the output shaft in the operation state.

In one example of the disclosure, the operation accessory includes a central hole configured to fit with the installation apparatus to achieve installation, where a hole wall of the central hole is formed with a groove recessed in a direction farther from the first axis; the installation apparatus includes a first installation piece formed with a first clamping portion and a second installation piece formed with a second clamping portion capable of fitting with the first clamping portion to clamp the operation accessory; the first installation piece is capable of moving to a first position and a second position relative to the second installation piece; in the case where the first installation piece moves to the first position, the first clamping portion is disengaged from the second clamping portion in a direction of the first axis; and in the case where the first installation piece moves to the second position, both the first clamping portion and the second clamping portion are inserted into the groove.

In one example of the disclosure, in the case where the first installation piece is switched from the second position to the first position, a distance between the first clamping portion and the second clamping portion that are inserted into the same groove in a circumferential direction around the first axis increases.

In one example of the disclosure, the first clamping portion has a first clamping surface in contact with a groove wall of the groove, and the second clamping portion has a second clamping surface in contact with the groove wall of the groove; the first clamping portion and the second clamping portion that are inserted into the same groove are defined as a clamping assembly; in the case where the first clamping portion is at the first position, a minimum dimension between the first clamping surface and the second clamping surface in a circumferential direction around the first axis is greater than a minimum dimension of the groove in the circumferential direction around the first axis.

In one example of the disclosure, the first installation piece further includes a supporting surface connected to the first clamping surface, the supporting surface is perpendicular to the first axis, the first clamping surface drives the operation accessory to rotate, and the supporting surface axially supports the operation accessory.

In one example of the disclosure, the second clamping surface is an inclined surface, and a plane where the second clamping surface is located obliquely intersects with the first axis.

In one example of the disclosure, in the case where the first installation piece is at the first position, in a direction parallel to the first axis, a distance between the first clamping portion and the second clamping portion is less than a thickness of the operation accessory.

In one example of the disclosure, the power tool is a multifunctional power tool and includes a motor and a transmission assembly. The transmission assembly drives the output shaft to swing and includes a transmission bearing and a shift fork. The transmission bearing is driven by the motor. The shift fork is connected to the output shaft and driven by the transmission bearing to swing back and forth to drive the output shaft to swing. The installation apparatus includes a first installation piece and a second installation piece. The operation accessory is installed between the first installation piece and the second installation piece. The first installation piece is formed with a first clamping portion, and the second installation piece is formed with a second clamping portion capable of fitting with the first clamping portion to clamp the operation accessory. The first installation piece is capable of moving to a first position and a second position relative to the second installation piece. In the case where the first installation piece moves to the first position, the first clamping portion is disengaged from the second clamping portion in a direction of the first axis. In the case where the first installation piece is operated to rotate around the first axis to the second position, the first clamping portion supports the operation accessory in an axial direction of the first axis, and the second clamping portion fixes the operation accessory in a radial direction of the first axis so that the operation accessory is capable of being driven to rotate by the second clamping portion.

In one example of the disclosure, the operation accessory includes a first installation hole and a second installation hole configured to fit with the installation apparatus to achieve installation, where the second installation hole surrounds the first installation hole.

In one example of the disclosure, the first installation hole forms an opening on the operation accessory.

In one example of the disclosure, a power tool includes a motor, an output shaft, and an installation apparatus. The output shaft is driven by the motor to rotate around a first axis in a first rotation direction. The installation apparatus is configured to install an operation accessory to the power tool and has an operation state and an installation state. In the case where the installation apparatus is in the operation state, the installation apparatus is capable of driving the operation accessory to move together with the output shaft. In the case where the installation apparatus is in the installation state, the installation apparatus allows the operation accessory to be installed to the installation apparatus and allows the operation accessory to be disassembled from the installation apparatus. The power tool further includes a retention mechanism, an inner shaft, and a limiting mechanism. The retention mechanism is capable of at least providing a retaining force that keeps the installation apparatus in the installation state. The inner shaft is connected to the installation apparatus. The limiting mechanism is connected to the inner shaft. In the case where the installation apparatus is in the installation state, the limiting mechanism is configured to prevent the inner shaft and the output shaft from rotating synchronously; and in the case where the installation apparatus receives a rotation force applied by the operation accessory, the rotation force triggers the retention mechanism to release a retention effect on the installation apparatus, and the installation apparatus is switched from the installation state to the operation state.

In one example of the disclosure, the power tool includes an operation piece connected to the inner shaft, where the operation piece is configured to drive the inner shaft to be displaced so that the installation apparatus is switched from the operation state to the installation state.

In one example of the disclosure, a transmission mechanism is connected to the motor and the output shaft and includes a first bevel gear and a second bevel gear that mesh with each other, and the limiting mechanism includes a third bevel gear; in the installation state, the third bevel gear meshes with the first bevel gear; and in the operation state, the third bevel gear is disengaged from the first bevel gear.

In one example of the disclosure, the limiting mechanism includes a limiting piece and a limiting groove disposed on the output shaft, the limiting piece is connected to the operation piece, and the limiting piece is placed in the limiting groove in the installation state.

In one example of the disclosure, the limiting mechanism includes a one-way bearing connected to the output shaft.

In one example of the disclosure, the limiting mechanism is capable of being switched between a state in which the output shaft is allowed to rotate and a state in which the output shaft is prevented from rotating.

### BRIEF DESCRIPTION OF DRAWINGS

FIG. 1 is a perspective view of a power tool according to an example;

FIG. 2 is a plan view of the power tool in FIG. 1;

FIG. 3 is a sectional view of the power tool in FIG. 1;

FIG. 4A is a structural view of a head of the power tool in FIG. 1 in an installation state;

FIG. 4B is a plan view of a head of the power tool in FIG. 1 in an operation state;

FIG. 5A is a sectional view of a head of the power tool in FIG. 1 in an installation state;

FIG. 5B is a sectional view of a head of the power tool in FIG. 1 in an operation state;

FIG. 6 is a view illustrating an inside of a head of the power tool in FIG. 1;

FIG. 7 is a schematic view illustrating an internal structure of a head of the power tool in FIG. 1;

FIG. 8 is a plan view of a structure in FIG. 6;

FIG. 9A is a structural view of an installation apparatus of the power tool in FIG.

1 in an installation state;

FIG. 9B is a structural view of an installation apparatus of the power tool in FIG. 1 in an operation state;

FIG. 10 is an exploded view of a head structure in FIG. 1;

FIG. 11 is a plan view of an operation accessory of the power tool in FIG. 1;

FIG. 12A is a plan view of the operation accessory in FIG. 11 in an installation state;

FIG. 12B is a plan view of the operation accessory in FIG. 11 in an operation state;

FIG. 13A is a plan view of a first clamping portion and a second clamping portion in a groove of an operation accessory in FIG. 1;

FIG. 13B is a plan view of a first clamping portion and a second clamping portion fitting with a transmission portion of an operation accessory in FIG. 1;

FIG. 14 is a plan view of a first clamping portion and a second clamping portion in FIG. 1 disengaged from each other;

FIG. 15A is a structural view of a limiting mechanism according to another example when an installation apparatus is in an installation state;

FIG. 15B is a structural view of the limiting mechanism in FIG. 15A when the installation apparatus is in an operation state;

FIG. 16A is a structural view of a limiting mechanism according to another example when an installation apparatus is in an installation state;

FIG. 16B is a structural view of the limiting mechanism in FIG. 16A when the installation apparatus is in an operation state;

FIG. 17A is a structural view of a limiting mechanism according to another example when an installation apparatus is in an installation state;

FIG. 17B is a structural view of the limiting mechanism in FIG. 17A when the installation apparatus is in an operation state;

FIG. 18 is a schematic view of a first installation piece in a groove of an operation accessory in an installation state of a power tool according to an example;

FIG. 19 is a plan view of a first installation piece and a second installation piece in a groove of an operation accessory in an operation state of a power tool according to an example;

FIG. 20 is a perspective view of a multifunctional power tool according to an example;

FIG. 21 is a sectional view of an inside of the multifunctional power tool in FIG. 20;

FIG. 22 is a perspective view of elements inside a front end casing in an installation state of the multifunctional power tool in FIG. 20;

FIG. 23 is a perspective view of elements inside a front end casing in an operation state of the multifunctional power tool in FIG. 20;

FIG. 24 is a plan view of the elements inside the front end casing in the installation state of the multifunctional power tool in FIG. 22;

FIG. 25 is a plan view of the elements inside the front end casing in the operation state of the multifunctional power tool in FIG. 23;

FIG. 26 is a structural view of an operation accessory applicable to the multifunctional power tool in FIG. 20;

FIG. 27 is a structural view of another operation accessory applicable to the multifunctional power tool in FIG. 20;

FIG. 28 is a structural view of another operation accessory applicable to the multifunctional power tool in FIG. 20;

FIG. 29 is a structural view of another operation accessory applicable to the multifunctional power tool in FIG. 20;

FIG. 30 is a plan view of elements inside a front end casing in an installation state of a multifunctional power tool according to an example;

FIG. 31 is a plan view of the elements inside the front end casing in an operation state of the multifunctional power tool in FIG. 30;

FIG. 32 is a structural view of an operation accessory applicable to the multifunctional power tool in FIG. 30;

FIG. 33 is a structural view of an operation accessory applicable to the multifunctional power tool in FIG. 30;

FIG. 34 is a schematic view of a relative position between the operation accessory in FIG. 32 and an installation apparatus in an installation state; and

FIG. 35 is a schematic view of a relative position between the operation accessory in FIG. 32 and an installation apparatus in an operation state.

### DETAILED DESCRIPTION

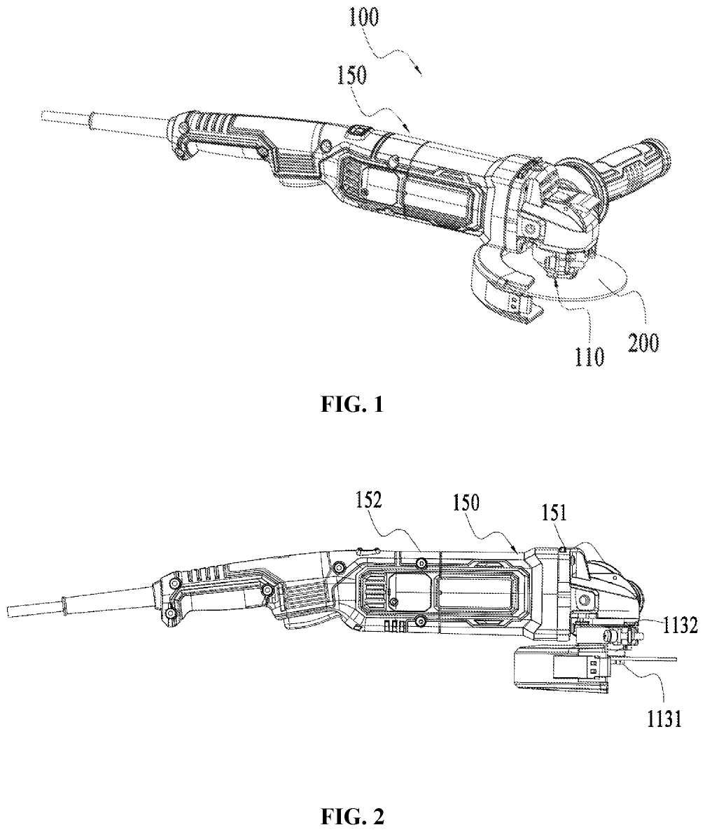

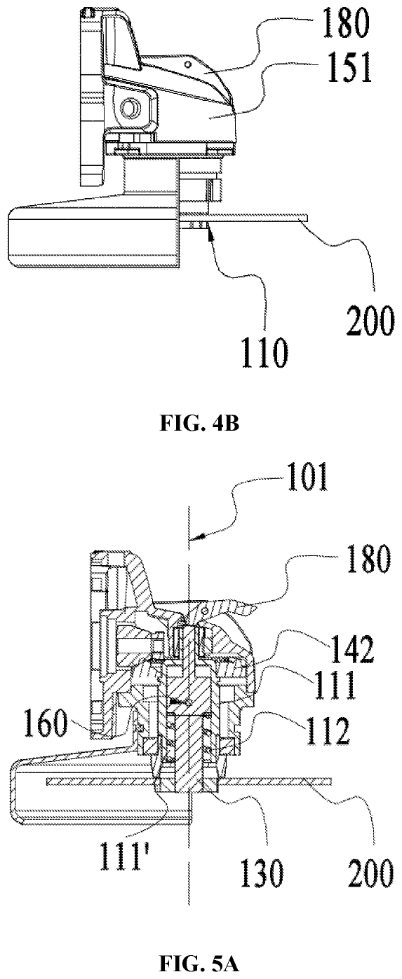

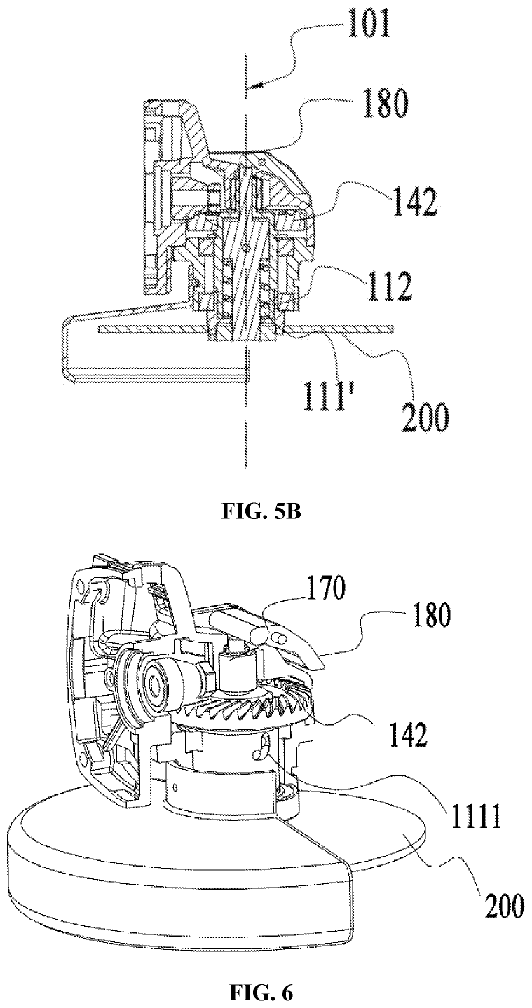

As shown in FIGS. 1 to 3, an example of the present application provides a power tool 100 which an operation assembly 200 can be quickly disassembled from and installed to. An angle grinder is used as an example. The power tool 100 includes a motor 120, an output shaft 111, a transmission mechanism 140, a casing 150, and an installation apparatus 110. The casing 150 is configured to support the motor 120 and the installation apparatus 110. The motor 120 is disposed in the casing 150. The installation apparatus 110 is configured to install the operation accessory 200 to the power tool and connected to the output shaft 111. The motor 120 is connected to a motor shaft 121 so that the motor 120 outputs power, the transmission mechanism 140 is connected to the motor shaft 121 and the output shaft 111, the motor 120 drives the motor shaft 121 to rotate, and the motor shaft 121 drives the output shaft 111 to rotate through the transmission mechanism 140 to drive the operation accessory 200 to rotate. As shown in FIGS. 4A to 5B, the installation apparatus 110 has an operation state and an installation state. In the case where the installation apparatus 110 is in the operation state shown in FIGS. 4B and 5B, the installation apparatus 110 can drive the operation accessory 200 to move together with the output shaft 111. In the case where the installation apparatus 110 is in the installation state shown in FIGS. 4A and 5A, the installation apparatus 110 allows the operation accessory 200 to be installed to the installation apparatus 110 and allows the operation accessory 200 to be disassembled from the installation apparatus 110. The output shaft 111 can rotate or swing around a first axis 101, and the transmission mechanism 140 is connected to the motor 120 and the installation apparatus 110. When the installation apparatus 110 is in the operation state, the output shaft 111 can drive the operation accessory 200 to rotate around the first axis 101 in a first rotation direction 301 through the installation apparatus 110.

The power tool 100 further includes a retention mechanism 160 which has a retention state in which the retention mechanism 160 can provide a retaining force that keeps the installation apparatus 110 in the installation state. As shown in FIG. 5A, the retention mechanism 160 is in the retention state and can provide the retaining force to the installation apparatus 110. Under the action of the retaining force, the installation apparatus 110 can be temporarily kept in the installation state so that a user can disassemble and install the operation accessory 200. When the installation apparatus 110 is in the installation state, the user inserts the operation accessory 200 into the installation apparatus 110 and then rotates the operation accessory 200 so that the operation accessory 200 applies a rotation force to the installation apparatus 110. At this time, the installation apparatus 110 receives the rotation force and the rotation force indirectly triggers the retention mechanism 160 to release the retaining force provided to the installation apparatus so that the installation apparatus 110 is switched from the installation state to the operation state and thus the operation accessory 200 is fixedly installed to the power tool 100. At this time, the user can start the power tool 100 to perform operations such as polishing and cutting.

In this example, the power tool 100 is the angle grinder, for example. The power tool may also be other power tools that can output power, such as a swing tool, a polisher, and an electric circular saw.

The power tool 100 further includes an inner shaft 130 that can rotate relative to the output shaft 111. The inner shaft 130 is connected to the installation apparatus 110. The installation apparatus 110 transmits the received rotation force to the inner shaft 130 so that the inner shaft 130 rotates relative to the output shaft 111 to trigger the retention mechanism 160 to release a retention effect on the installation apparatus 110. The inner shaft 130 is indirectly connected to and supports the operation accessory 200. In an example, the output shaft 111 is coaxially connected to the inner shaft 130. The output shaft 111 is formed with a receiving cavity 111′ around the first axis 101, and the inner shaft 130 passes through the receiving cavity 111′ along the first axis 101. Alternatively, the inner shaft 130 is completely disposed in the receiving cavity 111′; in this case, the output shaft 111 may also be regarded as an outer shaft around the inner shaft 130.

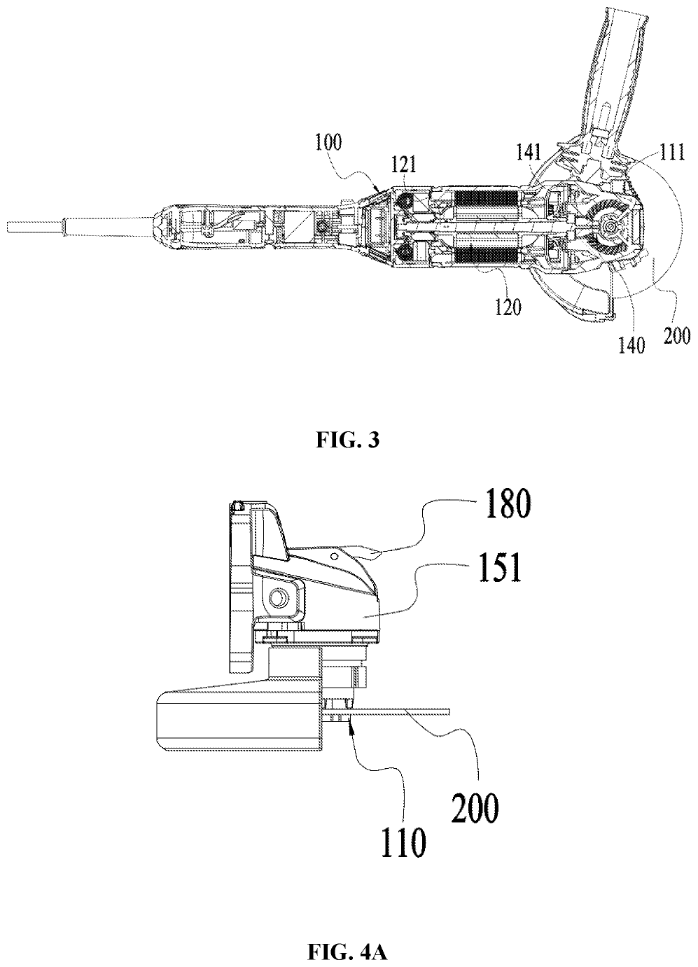

Referring to FIGS. 3 and 5A, the power tool 100 further includes an energy storage element 112 storing a driving force for driving the installation apparatus 110 to have a tendency to move toward the operation state. In the case where the installation apparatus 110 is in the installation state and receives the rotation force applied by the operation accessory 200, the inner shaft 130 rotates relative to the output shaft 111 to trigger the energy storage element 112 to exert the driving force to drive the installation apparatus 110 to move to the operation state. In an example, the energy storage element 112 is a spring disposed in the receiving cavity 111′, and the spring is sleeved on the inner shaft 130 and biases against the inner shaft 130 to produce the driving force. The operation state refers to a state in which the power tool 100 is allowed to drive the operation accessory 200 to operate and does not particularly refer to a state in which the power tool 100 drives the operation accessory 200 to rotate. After switching the installation apparatus 110 from the installation state to the operation state, the user turns on the power tool 100 so that the operation accessory 200 installed to the power tool 100 is driven to rotate.

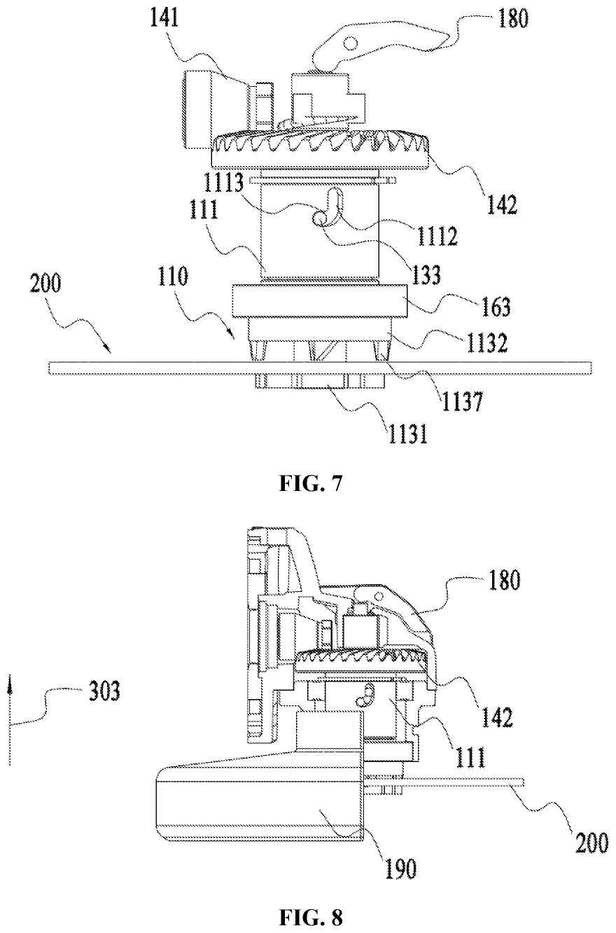

As shown in FIGS. 5A, 6, and 7, the retention mechanism 160 includes a guide rail 1111 and a movable piece 133 configured to slide in the guide rail 1111. The guide rail 1111 includes a first guide rail 1112 and a second guide rail 1113 that are smoothly connected. When the movable piece 133 slides to the second guide rail 1113, the retention mechanism 160 provides the retaining force that keeps the installation apparatus 110 in the installation state.

As shown in FIGS. 4A to 9B, the installation apparatus 110 includes a first installation piece 1131 and a second installation piece 1132 that are disposed opposite. The first installation piece 1131 and the second installation piece 1132 clamp the operation accessory 200 when fitting with each other and release the operation accessory 200 when disengaged from each other. The first installation piece 1131 is coupled to the inner shaft 130, and the inner shaft 130 is fixedly connected to the first installation piece 1131. The second installation piece 1132 is coupled to the output shaft 111, and the output shaft 111 is fixedly connected to the second installation piece 1132. The first installation piece 1131 is disposed at an end of the inner shaft 130, and the second installation piece 1132 is disposed at an end of the output shaft 111. The inner shaft 130 rotates around the first axis 101 relative to the output shaft 111 to drive the installation apparatus 110 to be switched between the installation state and the operation state. When the inner shaft 130 rotates around the first axis 101 in a second rotation direction 302, a whole formed by the inner shaft 130 and the first installation piece 1131 rotates from a first position to a second position in the second rotation direction 302, and the installation apparatus 110 enters the operation state. When the inner shaft 130 rotates around the first axis 101 in the first rotation direction 301, the whole formed by the inner shaft 130 and the first installation piece 1131 rotates from the second position to the first position in the first rotation direction 301, and the installation apparatus 110 enters the installation state.

The installation apparatus 110 is configured to keep the operation accessory 200 on the power tool 100 so that the first axis 101 substantially coincides with an axis of the output shaft 111.

The installation apparatus 110 is connected to the inner shaft 130 and rotates with the inner shaft 130 relative to the output shaft 111 to be switched between the installation state and the operation state and to unlock and lock the operation accessory 200 to the installation apparatus 110. A drive apparatus or the energy storage element 112 is triggered to exert the driving force through rotation of the installation apparatus 110, so as to drive a relative relationship between the installation apparatus 110 and a rotation apparatus to change from the installation state to the operation state.

The casing 150 includes a head casing 151 and a holding casing 152. The head casing 151 is connected to the holding casing 152, which are perpendicular or approximately perpendicular to each other. The head casing 151 is configured to package a head of the power tool 100. The installation apparatus 110 is connected to the head casing 151 and disposed partially inside the head casing 151. The output shaft 111 and the energy storage element 112 are at least partially exposed out of the head casing 151. The holding casing 152 is formed with a holding portion for the user to hold. In an example, the motor 120 and the motor shaft 121 are disposed inside the holding casing 152. The motor shaft 121 is designed to be perpendicular or approximately perpendicular to the output shaft 111, and the transmission mechanism 140 is connected to the motor shaft 121 and the output shaft 111. When the motor shaft 121 rotates, the output shaft 111 is driven to rotate through the transmission mechanism 140 and then drives the inner shaft 130 to rotate through the retention mechanism 160. The output shaft 111 is connected to the second installation piece 1132, and the inner shaft 130 drives the first installation piece 1131 so that a whole formed by the output shaft 111 and the inner shaft 130 drives the installation apparatus 110 to rotate and then the installation apparatus 110 drives the operation accessory 200 to rotate circularly.

The power tool 100 further includes an energy supply apparatus installed on or supported by the casing 150 and a control unit that controls the operation of the power tool 100. In this example, the energy supply apparatus is a power line connected to the external mains. In other examples, the energy supply apparatus may also be a battery pack. The battery pack is detachably installed to the casing 150 and connected to the motor 120 to supply power. The control unit generally adopts a circuit board assembly and is connected to the energy supply apparatus and the motor 120 to control the operation of the power tool 100.

The transmission mechanism 140 includes a first bevel gear 141 and a second bevel gear 142. The first bevel gear 141 is installed to the motor shaft 121 and can rotate synchronously with the motor shaft 121, and the second bevel gear 142 is installed to the output shaft 111 and can drive the output shaft 111 to rotate synchronously. The first bevel gear 141 and the second bevel gear 142 mesh with each other so that when the motor shaft 121 rotates, the first bevel gear 141 drives the second bevel gear 142 to rotate, the second bevel gear 142 drives the output shaft 111 to rotate synchronously, and the output shaft 111 can drive the inner shaft 130 to rotate synchronously, so as to achieve the vertical transmission of the motor shaft 121 to the inner shaft 130.

In an example, the output shaft is implemented as a casing piece surrounding the inner shaft 130, and the output shaft and the inner shaft 130 are connected by a limiting mechanism 170, where the limiting mechanism 170 is specifically a one-way bearing. The one-way bearing allows the relative rotation of the output shaft and the inner shaft 130 only in one direction. Here, it is defined that the output shaft is limited by the one-way bearing to be non-rotatable in the second rotation direction 302 so that the inner shaft 130 can rotate relative to the output shaft when receiving a force in the second rotation direction 302; the output shaft is not limited in the first rotation direction 301 so that the output shaft and the inner shaft 130 can rotate synchronously in the first rotation direction 301.

In addition to a shaft, the output shaft may also be a connector or other structures. In other examples, the output shaft is connected to the movable piece 133, the corresponding inner shaft 130 is provided with the guide rail and connected to the transmission mechanism through the output shaft, and the output shaft and the inner shaft 130 fit with each other to unlock or lock the operation accessory 200 and drive the operation accessory 200 to rotate in the operation state.

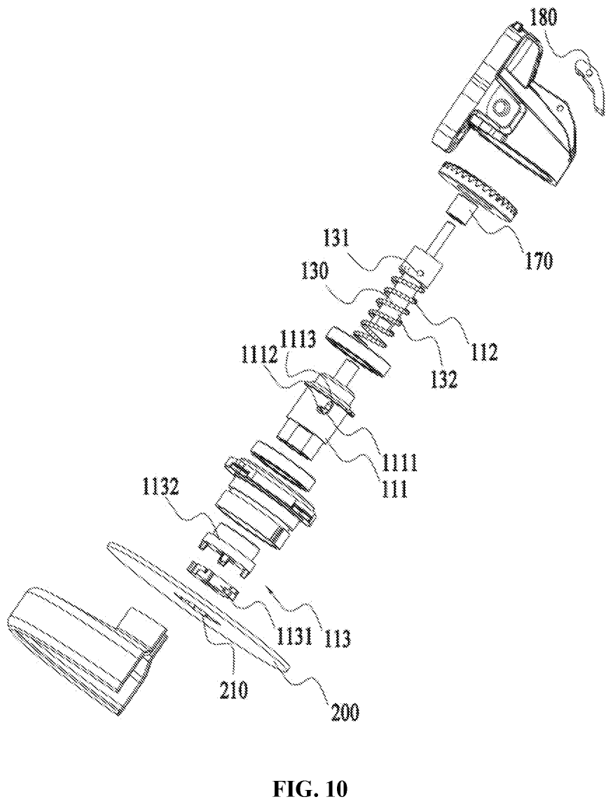

As shown in FIG. 10, the inner shaft 130 includes a first shaft portion 131 disposed in a middle of the inner shaft 130 and a second shaft portion 132 disposed at the end of the inner shaft 130. The second shaft portion 132 is closer to the installation apparatus 110 relative to the first shaft portion 131, and the second shaft portion 132 drives the installation apparatus 110 to rotate synchronously with the inner shaft 130 so that the operation accessory 200 connected to the installation apparatus 110 is driven to perform operations such as polishing, cutting, and winding.

A direction from the installation apparatus 110 to the transmission mechanism 140 on the first axis 101 is defined as a third direction 303. An average diameter of the second shaft portion 132 is less than an average diameter of the first shaft portion 131, and a sectional area of the second shaft portion 132 on a plane perpendicular to the first axis 101 is less than a sectional area of the first shaft portion 131 on this plane so that the energy storage element 112 can be placed on a periphery of the second shaft portion 132. In an example, the energy storage element 112 is an elastic piece such as a spring, and the spring is sleeved on the second shaft portion 132 of the inner shaft 130. In an example, the energy storage element 112 may also be configured to be other elastic pieces or other energy elements that can store energy when compressed and can release the stored energy.

In another example, the energy storage element is implemented as a motor and connected to an inductive element. When the inner shaft 130 rotates relative to the output shaft 111, the inductive element sends a signal to the motor and the motor provides a driving force to drive the inner shaft 130 to move upward relative to the output shaft 111 so that the installation apparatus 110 is locked. The energy storage element 112 may also be implemented as another apparatus that can provide the driving force when the operation accessory applies the rotation force to the installation apparatus.

The guide rail 1111 is formed on the output shaft 111 and a substantially L-shaped hole formed on the output shaft 111. The movable piece 133 is connected to the inner shaft 130. A height of a sliding trajectory of the movable piece 133 sliding in the guide rail 1111 in a direction of the first axis 101 is less than or equal to a height of the guide rail 1111 in the direction of the first axis 101. That is, under normal circumstances, the movable piece 133 generally does not slide to a top end of the guide rail 1111 when sliding along the guide rail 1111.

The movable piece 133 is disposed on a side wall of the first shaft portion 131 and configured to fit with the output shaft 111. The movable piece 133 is specifically a pin connected to the inner shaft 130. The movable piece 133 and the inner shaft 130 move synchronously in the direction of the first axis 101. The movable piece 133 and the inner shaft 133 move synchronously in a circumferential direction around the first axis 101. The pin is installed to the inner shaft 133, extends in a direction perpendicular to the first axis 101, and is inserted into the guide rail 1111 in the direction perpendicular to the first axis 101 to slide along the guide rail 1111. The pin penetrates the inner shaft 130 so that the movable piece 133 protrudes from a side wall of the inner shaft 130. Correspondingly, the output shaft 111 is provided with two guide rails 1111 matching positions of movable pieces 133, and the two guide rails 1111 are arranged centrosymmetrically relative to a certain point on the first axis 101. The movable pieces 133 disposed on two side walls of the inner shaft 130 are clamped to the guide rails 1111 at two ends, respectively, and the movable pieces 133 rotate synchronously in the two guide rails 1111.

The first guide rail 1112 is configured to extend in the direction of the first axis 101, the second guide rail 1113 is configured to extend in a direction approximately perpendicular to the first axis 101, and the second guide rail 1113 and the first guide rail 1112 smoothly communicate with each other so that the movable piece 133 can smoothly slide from the second guide rail 1113 to the first guide rail 1112. In the installation state, the movable piece 133 is clamped in the second guide rail 1113, and in the operation state, the movable piece 133 is clamped in the first guide rail 1112. During the switching from the installation state to the operation state, the movable piece 133 slides from the second guide rail 1113 to the first guide rail 1112 and is limited by the first guide rail 1112. During the switching from the operation state to the installation state, the movable piece 133 slides from the first guide rail 1112 to the second guide rail 1113 and is limited by the second guide rail 1113. When moving into the first guide rail 1112, the movable piece 113 is at a first retention position, and when moving into the second guide rail 1113, the movable piece 133 is at a second retention position. When the movable piece 133 moves from the second retention position to the first retention position, a whole formed by the movable piece 133 and the inner shaft 130 rotates by a preset angle relative to the output shaft 111. When moving from the first retention position to the second retention position, the movable piece 133 slides in the guide rail 1111 from the first guide rail 1112 to the second guide rail 1113 and provides the retaining force that keeps the installation apparatus 110 in the installation state in the second guide rail 1113.

In the operation state, the inner shaft 130 and the output shaft 111 rotate synchronously in the first rotation direction 301. When the installation apparatus 110 is switched from the installation state to the operation state, the first installation piece 1131 rotates relative to the second installation piece 1132 in the second rotation direction 302 opposite to the first rotation direction 301, and the first installation piece 1131 moves in the third direction 303 so that an axial distance between the first installation piece 1131 and the second installation piece 1132 is reduced. When the installation apparatus 110 is switched from the operation state to the installation state, the first installation piece 1131 rotates relative to the second installation piece 1132 in the first rotation direction 301, and the first installation piece 1131 moves in a direction opposite to the third direction 303 so that an axial distance between the first installation piece 1131 and the second installation piece 1132 is increased.

In the operation state, the first installation piece 1131 rotates relative to the second installation piece 1132 by 1° to 45° in the first rotation direction 301, so as to trigger the installation apparatus 110 to be switched from the operation state to the installation state. In the installation state, the first installation piece 1131 rotates relative to the second installation piece 1132 by 1° to 45° in the second rotation direction 302, so as to trigger the installation apparatus 110 to be switched from the installation state to the operation state.

In this manner, the user can install the operation accessory 200 by simply rotating the operation accessory 200 by a reasonable angle.

In the operation state, the first installation piece 1131 rotates relative to the second installation piece 1132 by 1° to 30° in the first rotation direction 301, so as to trigger the installation apparatus 110 to be switched from the operation state to the installation state. In the installation state, the first installation piece 1131 rotates relative to the second installation piece 1132 by 1° to 30° in the second rotation direction 302, so as to trigger the installation apparatus 110 to be switched from the installation state to the operation state. In an example, in the installation state, the first installation piece 1131 rotates relative to the second installation piece 1132 by 2° to 15° in the second rotation direction 302, so as to trigger the installation apparatus 110 to be switched from the installation state to the operation state. In this manner, the user can install the operation accessory 200 by simply rotating the operation accessory 200 by a relatively small angle, which is convenient for the user to operate. In this case, when the movable piece 133 moves from the first retention position to the second retention position, the movable piece 133 rotates relative to the output shaft 111 by 1° to 30°, and the first installation piece 1131 is driven to be disengaged from the second installation piece 1132. When moving from the first retention position to the second retention position, the movable piece 133 rotates relative to the outer shaft by 2° to 15°.

As shown in FIG. 10, the operation accessory 200 has a central hole 210 fitting with the first installation piece 1131, and a dimension of the central hole 210 is at least greater than a dimension of the first installation piece 1131. A hole wall of the central hole 210 of the operation accessory 200 is formed with a groove 211 recessed in a direction farther from a center of the central hole 210. Multiple grooves 211 are provided. A transmission portion 212 is disposed at intervals between the multiple grooves 211. The transmission portion 212 is configured to receive power output by the installation apparatus 110.

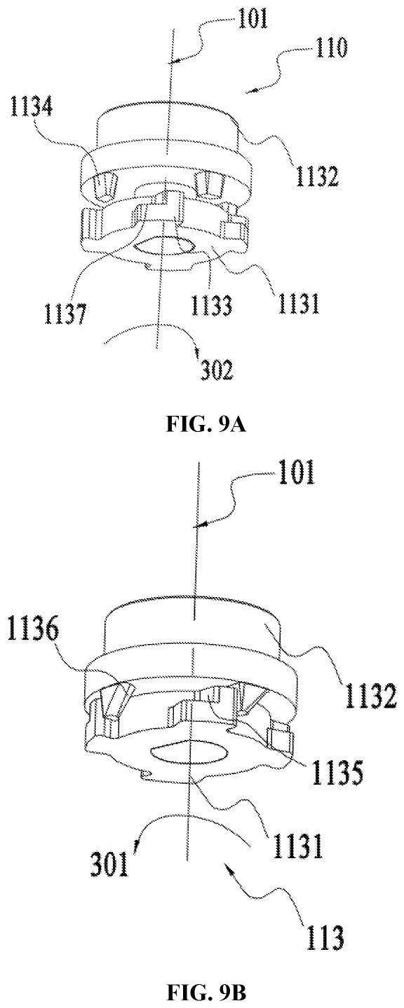

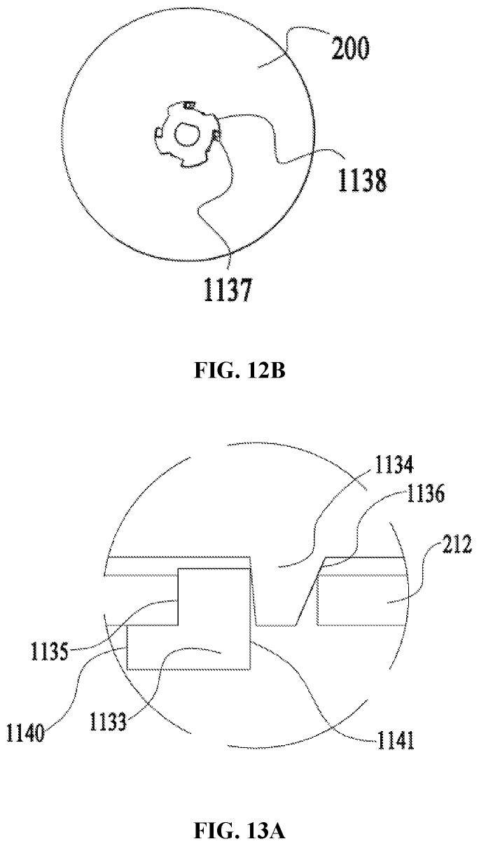

As shown in FIGS. 9A to 14, the first installation piece 1131 is formed with a first clamping portion 1133, and the second installation piece 1132 is formed with a second clamping portion 1134 capable of fitting with the first clamping portion 1133 to clamp the operation accessory 200. The first installation piece 1131 can move relative to the second installation piece 1132 to the first position and the second position; when the first installation piece 1131 moves to the first position, the first clamping portion 1133 is disengaged from the second clamping portion 1134 in the direction of the first axis 101, and the first clamping portion 1133 is also disengaged from the second clamping portion 1134 in the circumferential direction around the first axis 101. At this time, the installation apparatus 110 is in the installation state. When the first installation piece 1131 moves to the second position, the first installation piece 1131 at least partially overlaps with the second clamping portion 1134 in the direction of the first axis 101, and the first clamping portion 1133 is in contact with the second clamping portion 1134 in the circumferential direction around the first axis 101.

The installation apparatus 110 receives the rotation force applied by the operation accessory 200 so that the first installation piece 1131 moves to the first position and the second position relative to the second installation piece 1132. In the case where the first installation piece 1131 moves to the first position, the first clamping portion 1133 is disengaged from the second clamping portion 1134 in the direction of the first axis 101, and the installation apparatus 110 allows the operation accessory to be installed to the installation apparatus 110 and allows the operation accessory to be disassembled from the installation apparatus 110. In the case where the first installation piece 1131 moves to the second position, the first clamping portion 1133 at least partially overlaps with the second clamping portion 1134 in the direction of the first axis, and the installation apparatus 110 is capable of driving the operation accessory to move together with the output shaft.

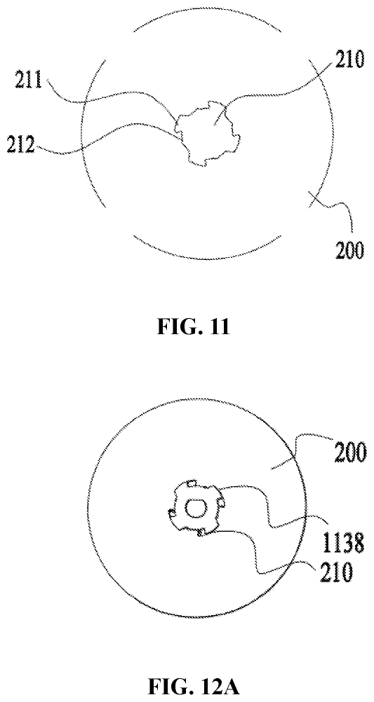

The first clamping portion 1133 has a first clamping surface 1135 in contact with the operation accessory 200, and the second clamping portion 1134 has a second clamping surface 1136 in contact with the operation accessory 200. When the installation apparatus 110 is in the operation state, the operation accessory 200 is connected to the installation apparatus 110. At this time, as shown in FIGS. 11 to 13B, the first installation piece 1131 is at the second position, and both the first clamping portion 1133 and the second clamping portion 1134 are inserted into the groove 211 formed on the operation accessory 200. The first clamping portion 1133 and the second clamping portion 1134 inserted into the same groove 211 are defined as a clamping assembly. For the groove 211, the first clamping portion 1133 is in contact with one side wall of the groove 211, and the second clamping portion 1134 in the groove 211 is in contact with another side wall of the groove 211. For the transmission portion 212, the second clamping portion 1134 in the groove 211 on a left side of the transmission portion 212 is in contact with one side wall of the transmission portion 212, and the first clamping portion 1133 in the groove 211 on a right side of the transmission portion 212 is in contact with another side wall of the transmission portion 212. In this manner, the operation accessory 200 can be clamped in the circumferential direction around the first axis so that the power tool 100 can output power to the operation accessory 200.

In an example, the second clamping surface 1136 is configured to be an inclined surface, and a plane where the second clamping surface 1136 is located obliquely intersects with the first axis so that the second clamping surface 1136 still has a clamping effect on the operation accessory after the installation apparatus is worn.

When the first installation piece 1131 moves from the second position to the first position, a distance between the first clamping portion 1133 and the second clamping portion 1134 inserted into the same groove in the circumferential direction around the first axis is increased gradually. However, the distance between the first clamping portion 1133 and the second clamping portion 1134 inserted into the same groove in the circumferential direction is still greater than a distance between the second clamping portion 1134 in another groove and the first clamping portion 1133 in the circumferential direction. That is, it can also be understood that the first clamping portion 1133 and the second clamping portion 1134 closest to the first clamping portion 1133 are defined as the clamping assembly. When the first installation piece 1131 moves from the second position to the first position, a distance between the first clamping portion 1133 and the second clamping portion 1134 in the clamping assembly in the direction of the first axis 101 is increased gradually. However, to prevent the operation accessory 200 from being jammed when the operation accessory 200 is disassembled, in this example, when the first installation piece 1131 is at the first position, a minimum dimension L1 between the first clamping surface 1135 and the second clamping surface 1136 in the clamping assembly in the circumferential direction around the first axis 101 is made greater than a minimum dimension of the groove 211 in the circumferential direction around the first axis 101; and a distance L2 between the first clamping portion 1133 and the second clamping portion 1134 in the direction of the first axis 101 is made less than a thickness of the operation accessory 200 in the direction of the first axis 101. In an example, to prevent the operation accessory 200 from being jammed when the operation accessory 200 is disassembled, in this example, when the first installation piece 1131 is at the first position, the minimum dimension L1 between the first clamping surface 1135 and the second clamping surface 1136 in the clamping assembly in the circumferential direction around the first axis 101 is made greater than or equal to 6 mm; and the distance L2 between the first clamping portion 1133 and the second clamping portion 1134 in the direction of the first axis 101 is made greater than 0 mm and less than or equal to 3 mm.

The energy storage element 112 stores a driving force for driving the first installation piece 1131 to have a tendency to move to the second position. In the case where the installation apparatus 110 is in the installation state and receives the rotation force applied by the operation accessory 200, the energy storage element 112 exerts the driving force to drive the first installation piece 1131 to move to the second position. The energy storage element 112 provides the driving force to make the inner shaft 130 and the movable piece 133 move axially.

After driving the operation accessory 200 for a long time, the first installation piece 1131 is easily worn by the operation accessory 200, which reduces the stability of the installation apparatus 110 locking the operation accessory 200. To solve this problem, the present application further provides a solution for preventing the operation accessory from being fixed with low accuracy due to wear. The first clamping portion 1133 is further formed with a first supporting surface 1137 for supporting the operation accessory. The first clamping surface 1135 is parallel to the first axis 101, and the first supporting surface 1137 is perpendicular to the first axis 101. The first supporting surface 1137 and the first clamping surface 1135 are connected and rotate synchronously. The second installation piece 1132 has a lower surface 1138, and the second clamping portion 1134 is a protrusion extending downward from the lower surface 1138. A distance between the first supporting surface 1137 and the lower surface 1138 is greater than the thickness of the operation accessory 200 by a preset value L, and a dimension of the first clamping surface 1135 in the direction of the first axis 101 is less than the distance between the first supporting surface 1137 and the lower surface 1138. In this manner, when the operation accessory 200 is worn, the first clamping portion 1133 may be closer to the lower surface 1138 in the direction of the first axis to clamp the operation accessory. Correspondingly, a height of the first guide rail 1112 in the direction of the first axis 101 is greater than a height corresponding to a position where the movable piece 133 stays in the first guide rail 1112 in an initial unworn state by a distance at least greater than or equal to the preset value L. The first clamping surface 1135 is configured to be in contact with the operation accessory 200 and drive the operation accessory 200 to rotate, and the first supporting surface 1137 is configured to be in contact with the operation accessory 200 and support the operation accessory 200 to the installation apparatus 110.

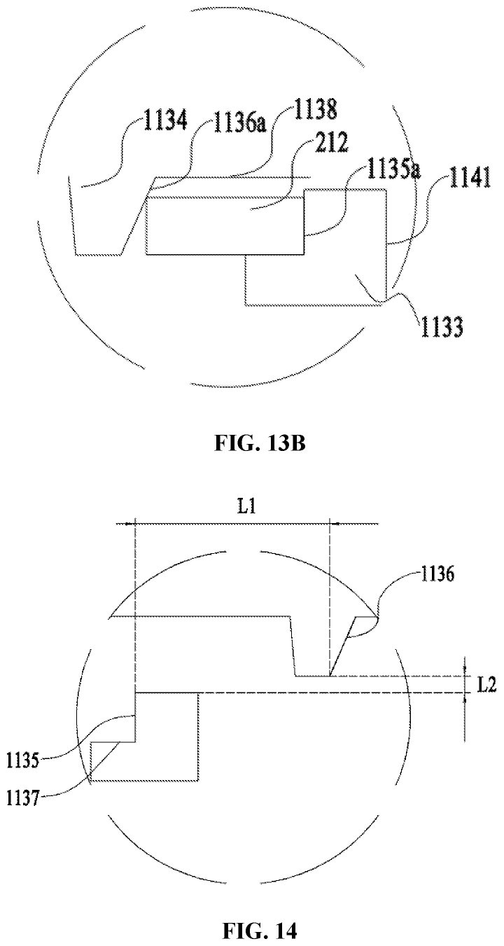

Referring to FIG. 13B, in a clamping plane parallel to the first axis 101 and intersecting with the first clamping surface 1135 and the second clamping surface 1136, the first clamping surface 1135 has a first line of intersection 1135a that intersects with the clamping plane, and the second clamping surface 1136 has a second line of intersection 1136a that intersects with the clamping plane. In this case, the clamping plane may be understood as a paper plane in the figure; a straight line where the first line of intersection 1135a is located obliquely intersects with a straight line where the second line of intersection 1136a is located. Therefore, after the first clamping surface 1135 or the second clamping surface 1136 is worn, the first clamping surface 1135 and the second clamping surface 1136 intersect with the plane to be in an inclined state so that the first clamping surface 1135 and the second clamping surface 1136 can adapt to a wear condition of the operation accessory 200, so as to improve the stability of the installation apparatus 110 locking the operation accessory 200. Specifically, the first clamping surface 1135 is in contact with the transmission portion 212 of the operation accessory 200, and the second clamping surface 1136 is in contact with the transmission portion 212 of the operation accessory 200. When the first clamping surface 1135 and the second clamping surface 1136 are worn, a position of the first clamping surface 1135 in contact with the transmission portion 212 and a position of the second clamping surface 1136 in contact with the transmission portion 212 are changed so that the operation accessory 200 is clamped.

In an example, in the operation state, the first clamping surface 1135 is in contact with a groove wall of the groove 211, the second clamping surface 1136 is in contact with another groove wall of the groove 211, the first supporting surface 1137 supports a lower surface of the operation accessory 200, and the second clamping surface 1136 is an inclined surface. In this manner, the second clamping surface 1136 and the first supporting surface 1137 fit with each other so that the operation accessory 200 is clamped in the direction of the first axis 101; the second clamping surface 1136 and the first clamping surface 1135 fit with each other so that the operation accessory 200 is clamped in the circumferential direction around the first axis 101. In the operation state, the first installation piece 1131 partially penetrates the central hole 210, the first supporting surface 1137 supports the operation accessory 200, and a projection of the first supporting surface 1137 on the plane perpendicular to the first axis 101 is located outside a projection of the central hole 210 on this plane.

The first installation piece 1131 further includes a first alignment surface 1140 and a second alignment surface 1141 on two sides of the first clamping portion 1133. The first alignment surface 1140 is connected to the first supporting surface 1137, and the second alignment surface 1141 is disposed opposite to the first clamping surface 1135. When the operation accessory 200 is installed to the second installation piece 1132, the first alignment surface 1140 and the second alignment surface 1141 cause the central hole 210 of the operation accessory 200 to fit with the first clamping portion 1133, and the first alignment surface 1140 and the second alignment surface 1141 abut against or approach side walls of the central hole 210, respectively, so that the first clamping portion 1133 corresponds to the central hole 210 to guide the operation accessory 200 to move.

In an example, when the operation accessory 200 is installed to the power tool 100, generally, the central hole 210 of the operation accessory 200 is aligned with the first installation piece 1131 and the groove 211 is aligned with the first clamping portion 1133, and then the first alignment surface 1140 and the second alignment surface 1141 guide the operation accessory 200 so that the operation accessory 200 is sleeved on the second installation piece 1132 and thus the first supporting surface 1137 of the first installation piece passes through the central hole 210 along the first axis 101. At this time, the user rotates the operation accessory 200 in the second rotation direction 302 so that the operation accessory 200 rotates until the transmission portion 212 is in contact with the first clamping surface 1135 and the first supporting surface 1137 is staggered from the groove 211, and then the user continues rotating the operation accessory 200 in the second rotation direction 302 so that the operation accessory 200 is in contact with the first clamping surface 1135 through the transmission portion 212 to transmit the rotation force to the first clamping portion 1133. In this case, the output shaft 111 is prevented from rotating in the second rotation direction 302. Since the output shaft 111 is prevented by the one-way bearing from rotating in the second rotation direction 302, when the first clamping portion 1133 transmits the rotation force to the inner shaft 130 to drive the inner shaft to rotate around the first axis 101, the output shaft 111 does not rotate, and the inner shaft 130 drives the movable piece 133 to rotate in the guide rail 1111 to be disengaged from the second guide rail 1113. When the inner shaft 130 drives the movable piece 133 to rotate relative to the output shaft 111 to be disengaged from the second guide rail 1113, a friction force between the movable piece 133 and the output shaft 111 and a friction force generated by the spring need to be overcome. In this manner, when the movable piece 133 is disengaged from the second guide rail 1113, the second guide rail 1113 no longer limits the movable piece 133, and the retention mechanism 160 no longer provides the retaining force so that the inner shaft 130 no longer compresses the energy storage element 112, and the energy storage element 112 exerts the driving force. The driving force pushes the inner shaft 130 to move upward to drive the movable piece 133 to slide into the first guide rail 1112. When the inner shaft 130 is driven to move upward, the movable piece 133 is limited by the guide rail 1111 and driven to rotate in the second rotation direction 302 so that the first clamping portion 1133 rotates partially into the central hole 210 and is inserted into the groove 211, and the first supporting surface 1137 is staggered from the central hole 210. The first supporting surface 1137 supports the operation accessory 200 and drives the operation accessory 200 to move in the third direction 303 so that the second installation piece 1132 is inserted into the central hole 210 and the second clamping portion 1134 is inserted into the groove 211 of the central hole 210, and the first clamping surface 1135 is in contact with one side of the groove 211 and the second clamping surface 1136 is in contact with another side of the groove; thus, the installation apparatus 110 positions the operation accessory 200 in the circumferential direction. Moreover, since the second clamping surface 1136 is the inclined surface and the first supporting surface 1137 is in contact with the lower surface of the operation accessory 200, the installation apparatus 110 can position the operation accessory 200 in the direction of the first axis 101. The movable piece 133 slides between the first guide rail 1112 and the second guide rail 1113 so that the first installation piece 1131 moves axially and rotates circumferentially at the same time.

The second installation piece 1132 mainly prevents the operation accessory 200 and the first installation piece 1131 from being displaced due to inertia when the power tool 100 stops operating and enhances the installation stability of a locking assembly and the operation accessory 200. During the operation of the power tool 100, the first installation piece 1131 drives and supports the operation accessory 200 to operate.

The power tool 100 further includes an operation piece 180 for the user to operate to switch the power tool 100 from the operation state to the installation state. At this time, the first installation piece 1131 is disengaged from the second installation piece 1132. The operation piece 180 includes an operation portion operated by the user. The operation piece 180 is connected to the inner shaft 130. In an example, the operation piece 180 is disposed on an upper part of the head casing 151. The operation piece 180 may be configured to be a wrench and has a curved surface at a position of the operation piece 180 connected to the inner shaft 130 so that the wrench may be pulled in the direction opposite to the third direction 303 to push the inner shaft 130 to move in the direction opposite to the third direction 303 and compress the energy storage element 112. When the operation piece 180 drives the inner shaft 130 to move downward, the movable piece 133 can be driven together to slide into the second guide rail 1113. At this time, the inner shaft 130 and the movable piece 133 rotate together in the first rotation direction 301 so that a projection of the first clamping portion 1133 in the third direction 303 is located within a projection of the central hole 210 in the third direction 303, the operation accessory 200 is unlocked from the first installation piece 1131 and can be disengaged from the inner shaft 130, and thus the operation accessory 200 is unlocked from the installation apparatus 110.

In an example, the energy storage element 112 is unlocked through the rotation of the installation apparatus 110, provides a first force in the operation state, and provides a second force different from the first force in the installation state, so as to trigger a mutual switch between the installation state and the operation state of the installation apparatus 110 and the rotation apparatus.

The operation piece 180 is rotatably connected to the head casing 151. An axis around which the operation piece 180 rotates relative to the head casing 151 is perpendicular to the first axis 101 and also perpendicular to the axis around which the motor shaft 121 rotates. In this manner, the user can rotate the operation piece 180 with more convenience and less efforts.

Similarly, when the user needs to disassemble the operation accessory 200 installed to the power tool 100, the user rotates the operation piece 180. When the operation piece 180 rotates, the curved surface on the operation piece 180 triggers the inner shaft 130 to move downward. The inner shaft 130 drives the movable piece 133 and the first installation piece 1131 to move downward together. At the same time, the inner shaft 130 compresses the energy storage element 112 for the energy storage element 112 to store energy. When moving downward, the movable piece 133 is disengaged from the first guide rail 1112 and then continues to move from the first guide rail 1112 to the second guide rail 1113. At this time, the movable piece 133 rotates around the first axis 101 in the first rotation direction 301 by a certain angle, and the movable piece 133 rotating by a certain angle drives the inner shaft 130 and the first installation piece 1131 fixedly connected to the inner shaft 130 to rotate together by a certain angle in the first rotation direction 301. When the first installation piece 1131 is driven to move downward along the first axis 101, the second clamping portion 1134 is disengaged upward from the operation accessory 200. At this time, only the first clamping portion 1133 is inserted into the groove 211. When the first installation piece 1131 is driven to rotate in the first rotation direction 301, the first clamping surface 1135 applies an impact force to the side wall of the groove 211. The impact force triggers the operation accessory 200 to rotate together with the first installation piece 1131 in the first rotation direction 301 and further rotate by another angle relative to the first installation piece 1131 in the first rotation direction 301. The operation accessory 200 rotates relative to the first installation piece 1131 so that the first supporting surface 1137 no longer supports the operation accessory and moves to a position corresponding to the groove 211. At this time, a projection of the first installation piece 1131 in a plane of the first axis 101 is located within a projection of the central hole 210 in this plane. In this manner, under the action of gravity, the operation accessory 200 automatically falls and is disengaged from the power tool. That is, in a process of disassembling the operation accessory 200 installed to the power tool 100, the user may only need to rotate the operation piece 180 and then the operation accessory 200 can be automatically disengaged from the power tool 100, which is convenient for the user to operate.

In this example, the limiting mechanism 170 is implemented as the one-way bearing and further includes a buffer rubber. The one-way bearing is sleeved on the output shaft 111 and connected to a buffer rubber column supported by the head casing 151. The one-way bearing limits the output shaft 111 such that the output shaft 111 is non-rotatable in the second rotation direction 302 and rotatable in the first rotation direction 301 so that the output shaft 111 can rotate relative to the inner shaft 130 only in the installation state and during a switch between the installation state and the operation state. In the operation state, the output shaft 111 and the inner shaft 130 rotate synchronously. The buffer rubber is configured to decelerate the output shaft 111 to stop the output shaft 111 when the power tool 100 stops operating.

In this example, the limiting mechanism 170 is specifically the one-way bearing. In other examples, the limiting mechanism 170 may also be another mechanism that limits the output shaft 111 such that the output shaft 111 can rotate relative to the inner shaft 130 only during the mutual switch between the operation state and the installation state and the output shaft 111 rotates synchronously with the inner shaft 130 in the operation state.

In an example of the limiting mechanism, the limiting mechanism is connected to the output shaft 111, the output shaft 111 rotates in the first rotation direction 301 in the operation state, and the limiting mechanism limits the output shaft 111 such that the output shaft 111 can rotate relative to the inner shaft 130 only in the second rotation direction 302 in at least a non-operation state, where the second rotation direction 302 is opposite to the first rotation direction 301.

A state in which the power tool 100 drives the operation accessory 200 to rotate in the first rotation direction 301 is defined as the operation state, and a process state of the mutual switch between the installation state and the operation state is defined as the installation state. In the operation state, the limiting mechanism does not limit the rotation of the output shaft 111 so that the output shaft 111 and the inner shaft 130 rotate synchronously; in the installation state, the limiting mechanism limits the rotation of the output shaft 111 so that the inner shaft 130 can rotate relative to the output shaft 111 through the guide rail 1111. In this manner, the rotation of the installation apparatus 110 is controlled for switching between the operation state and the installation state of the installation apparatus 110.

In an example of the limiting mechanism, when the installation apparatus 110 is in the operation state, the output shaft 111 can drive the operation accessory 200 to rotate around the first axis 101 in the first rotation direction 301; the power tool 100 further includes the limiting mechanism that prevents the output shaft 111 from rotating around the first axis 101 in the second rotation direction 302 opposite to the first rotation direction 301.

In an example of the limiting mechanism, the power tool 100 further includes the limiting mechanism capable of being switched between a state in which the output shaft 111 is allowed to rotate and a state in which the output shaft 111 is prevented from rotating. The limiting mechanism may be a shaft lock that can transmit power in one direction, that is, the output shaft 111 is allowed to transmit power to the inner shaft 130, but the inner shaft 130 is not allowed to transmit power to the output shaft 111.

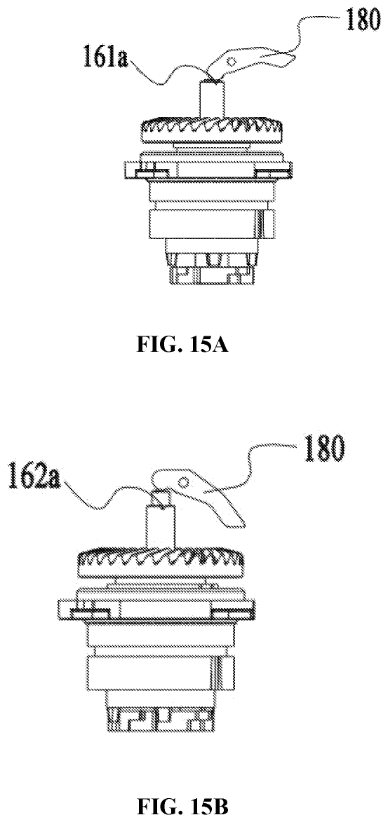

As shown in FIGS. 15A and 15B, the limiting mechanism is configured to be a limiting piece 161a and a limiting groove 162a disposed on the output shaft 111, the limiting piece 161a is disposed on the operation piece 180 and fits with the limiting groove 162a in structure, and the limiting piece 161a and the limiting groove 162a are designed to be non-cylindrical, and the limiting piece 161a and the limiting groove 162a are designed to be non-spherical. In this manner, when the limiting piece 161a is placed in the limiting groove 162a, the limiting piece 161a fits with the limiting groove 162a so that the output shaft 111 is fixed by the operation piece through the movable piece 133. The limiting piece is placed in the limiting groove in the installation state. In an unlocking process, the operation piece is pulled in the direction opposite to the third direction 303 so that the inner shaft 130 is pushed downward in the third direction 303. At this time, the installation apparatus is in the installation state, and the limiting piece 161a moves relatively downward and enters the limiting groove 162a so that the rotation of the output shaft 111 is limited. During locking, the inner shaft 130 is pushed upward, and the operation piece is pushed upward through the inner shaft 130. At this time, the installation apparatus enters the operation state, the limiting piece 161a is disengaged from the limiting groove 162a, and the limiting piece 161a no longer limits the rotation of the output shaft 111. Thus, the synchronous rotation of the output shaft relative to the inner shaft can be limited in the installation state, and the user can operate the operation accessory to drive the inner shaft to rotate relative to the output shaft so that the installation apparatus is switched from the installation state to the operation state.

In another example, the limiting mechanism is disposed in a holding portion, connected to a driver circuit that controls the motor, and connected to the output shaft 111. The limiting mechanism may be configured to control the motor to stop rotating and limit the rotation of the output shaft 111 in the installation state while controlling the motor to stop rotating.

In an example, the limiting mechanism may be configured to be other movable elements that lock and limit the rotation of the output shaft 111 in the installation state and do not limit the rotation of the output shaft 111 in the operation state.

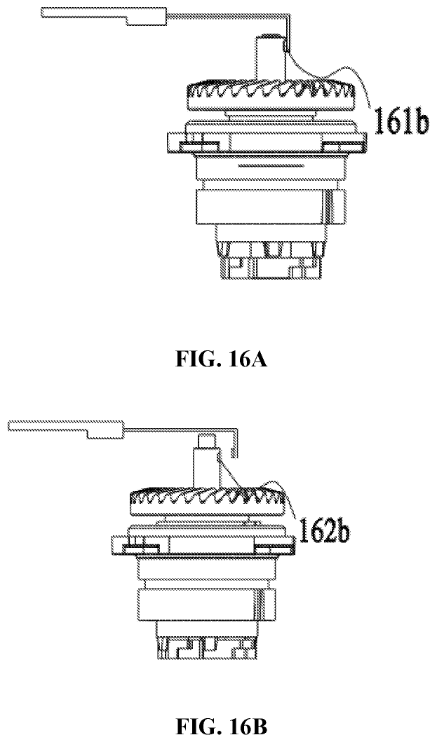

As shown in FIGS. 16A and 16B, in another example, the power tool includes a switch configured to control the power tool to be turned on, the limiting mechanism includes a limiting piece 161b and a limiting groove 162b disposed on the output shaft 111, and the limiting piece 161b is connected to the switch and fits with the limiting groove 162b in structure so that when the movable piece 133 is placed in the limiting groove 162b, the limiting piece 161b fits with the limiting groove 162b so that the output shaft 111 is fixed by the operation piece through the limiting piece 161b. When the user toggles the switch to turn on the power tool, the power tool enters the operation state, and the inner shaft 130 and the output shaft 111 rotate synchronously in the first rotation direction 301 and drive the operation accessory 200 to operate. When the user controls the switch to turn off the power tool, the switch drives the movable piece 133 connected to the switch to move so that the movable piece 133 is placed in the guide rail 1111 of the output shaft 111 to limit the rotation of the output shaft 111, and thus the output shaft 111 can rotate in the operation state and cannot rotate in the installation state, so as to fit with the switch between the operation state and the installation state of the installation apparatus 110.

In the unlocking process, the operation piece is pulled in the direction opposite to the third direction 303 so that the inner shaft 130 is pushed downward in the third direction 303. At this time, the movable piece 133 moves relatively downward and enters the guide rail 1111 to limit the rotation of the output shaft 111. In an example, during locking, the inner shaft 130 is pushed upward, and the operation piece is pushed upward through the inner shaft 130 so that the movable piece 133 is disengaged from the guide rail 1111, and the movable piece 133 no longer limits the rotation of the output shaft 111. In an example, the operation piece may also be another structure that can drive the inner shaft to be displaced in an axial direction of the first axis, such as a knob provided with threads.

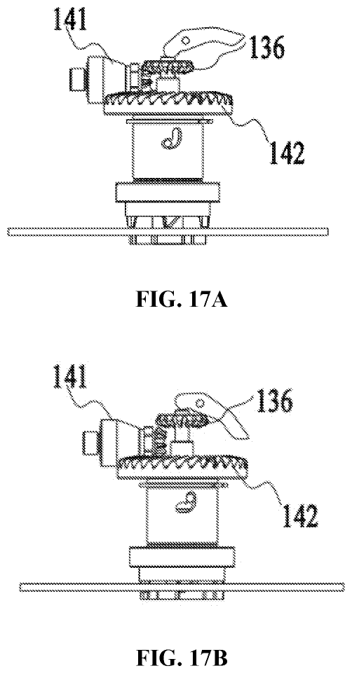

As shown in FIGS. 17A and 17B, in an example of the limiting mechanism, the limiting mechanism is connected to the inner shaft 130 and implemented as a third bevel gear 136, and in the installation state, the limiting mechanism meshes with the first bevel gear in a direction opposite to a direction in which the second bevel gear meshes with the first bevel gear so that the output shaft 111 and the inner shaft 130 can only rotate in opposite directions. In this manner, in the operation state, the user can disengage the limiting mechanism from the output shaft 111 and thus the third bevel gear no longer meshes with the first bevel gear.

In this example, the first clamping surface 1135 and the second clamping surface 1136 are configured to be inclined surfaces so that the first clamping portion 1133 is not necessarily closely attached to a side of the central hole 210, and the second clamping portion 1134 is not necessarily closely attached to a side of the central hole 210. In this manner, when a distance between the first clamping portion 1133 and the side of the central hole 210 is different, the operation accessory 200 is driven to operate by a position of the first clamping surface 1135 connected to the side of the central hole 210 at a different height so that the stability of the installation apparatus 110 locking the operation accessory 200 is improved and the effective service life of the installation apparatus 110 is extended. The first clamping surface 1135 is configured to be an inclined surface, which means that the first clamping surface 1135 is parallel to the first axis 101 but obliquely intersects with an axial direction along which the motor shaft 121 rotates. The second clamping surface 1136 is configured to be an inclined surface, which means that the second clamping surface 1136 obliquely intersects with the first axis 101. The second clamping surface 1136 is designed to be the inclined surface so that the operation accessory 200 can be driven not only when the distance between the first clamping portion 1133 and the side of the central hole 210 is fixed; when a distance between the first clamping portion 1133 and the side of the central hole 210 is different, the first clamping portion 1133 abuts against the side of the central hole 210 at a different height. In this manner, the stability of installing and driving the operation accessory 200 can be ensured.

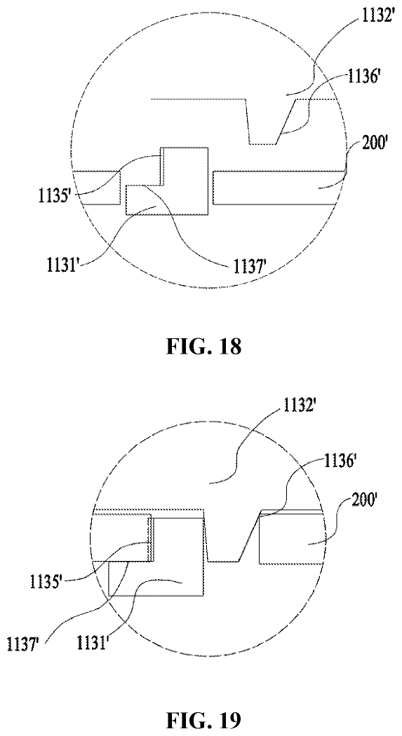

FIG. 18 shows a connection relation when a first installation piece is in a groove of an operation accessory in an installation state of a power tool according to an example. FIG. 19 is a plan view of a first installation piece and a second installation piece in a groove of an operation accessory in an operation state of a power tool according to an example. Referring to FIGS. 18 and 19, example two of the present application provides a power tool to which a grinding disc or an operation accessory 200′ is installed, the grinding disc has an installation hole, the installation hole includes a central hole and multiple grooves extending in a direction farther from the first axis and formed on a periphery of the central hole, and the groove has a first side wall and a second side wall opposite to the first side wall. The power tool includes an output shaft that is driven to move from an installation position toward a locking position. An adapter interface or a first installation piece 1131′ is connected to the output shaft and used for installing the grinding disc, the adapter interface or the first installation piece 1131′ has a first surface and an outer periphery of the first surface, and the outer periphery of the first surface of the adapter interface or the first installation piece 1131′ is constructed to fit with an outer periphery of the installation hole of the grinding disc. Multiple bumps are formed on the first surface of the adapter interface, and the bump has a first supporting surface 1137′ opposite to the first surface of the adapter interface and a first clamping surface 1135′ adjacent to the first supporting surface 1137′. A locking piece or a second installation piece 1132′ and the adapter interface lock the grinding disc together. The locking piece has multiple protrusions, and each protrusion has a second limiting surface 1136′. When the output shaft is at the installation position, the outer periphery of the adapter interface or the first installation piece 1131′ fits with the outer periphery of the installation hole of the grinding disc.

When the output shaft is at the locking position, the first clamping surface 1135′ on the adapter interface abuts against the first side wall of the groove of the grinding disc, and the first supporting surface 1137′ abuts against a first surface of the grinding disc to axially position the grinding disc. The protrusion of the locking piece abuts against the bump of the adapter interface, and the second limiting surface 1136′ of the protrusion abuts against the second side wall of the grinding disc opposite to the first side wall. The first clamping surface 1135′ of the bump and the second limiting surface 1136′ of the protrusion together radially position the grinding disc.

Another example provides a power tool to which a grinding disc or an operation accessory is installed, the grinding disc has an installation hole, the installation hole includes a central hole and multiple grooves extending in a direction farther from the first axis and formed on a periphery of the central hole. The power tool includes an output shaft that is driven to move from an installation position toward a locking position. An adapter interface or a first installation piece is connected to the output shaft and used for installing the grinding disc, the adapter interface or the first installation piece has a first surface and an outer periphery of the first surface, and the outer periphery of the first surface of the adapter interface or the first installation piece is constructed to fit with an outer periphery of the installation hole of the grinding disc. Multiple bumps are formed on the first surface of the adapter interface, and the bump has a first supporting surface opposite to the first surface of the adapter interface and a first clamping surface adjacent to the first supporting surface. When the output shaft is at the installation position, the outer periphery of the adapter interface or the first installation piece fits with the outer periphery of the installation hole of the grinding disc; when the output shaft is at the locking position, the first supporting surface on the adapter interface or the first installation piece axially positions the grinding disc and the first clamping surface radially positions the grinding disc so that the grinding disc is locked.

The installation apparatus provided in the present application can be applied to various power tools that rotate to operate, such as an angle grinder and a sander. The angle grinder further includes a protective cover connected to the head casing and configured to surround the operation accessory to protect the user, and the operation accessory is implemented as the grinding disc, which is not described in detail herein.

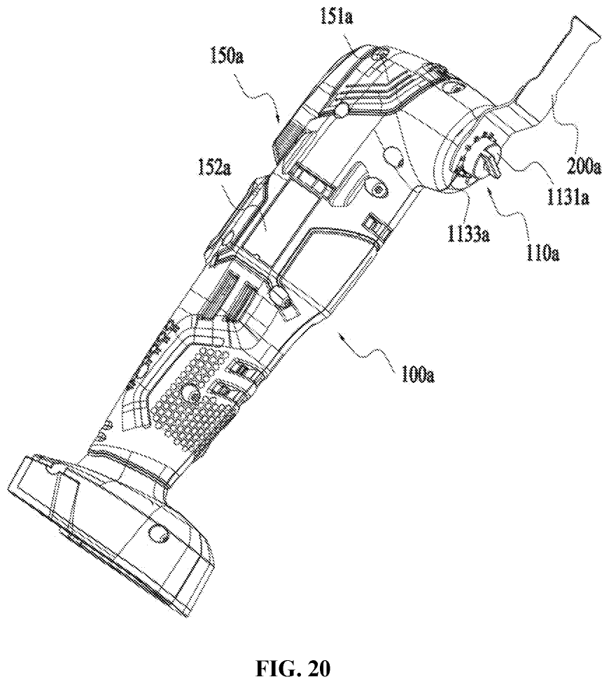

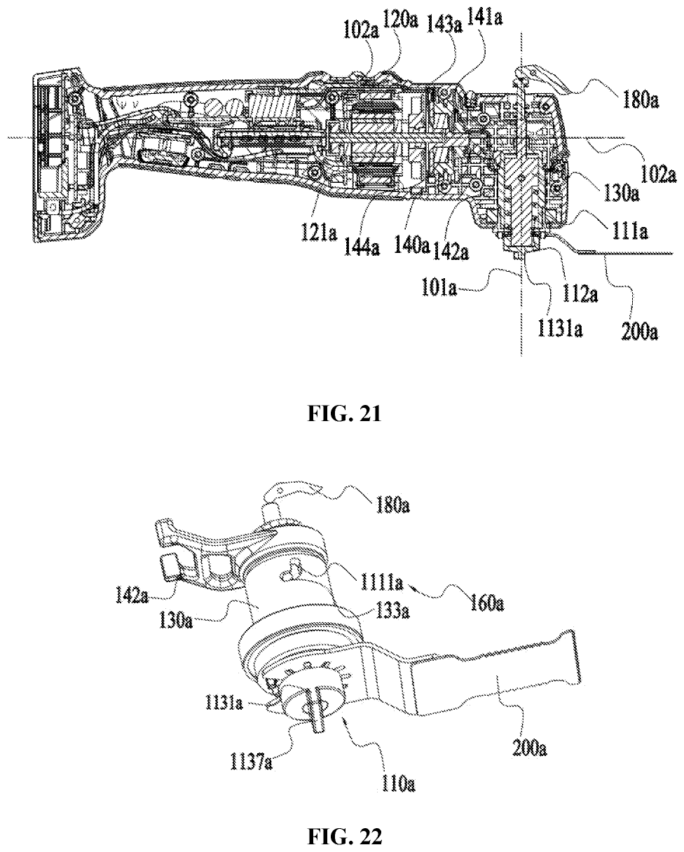

In an example, as shown in FIGS. 20 and 21, a power tool provided in the present application is a multifunctional power tool 100a that can drive an operation accessory to swing and includes a casing 150a, a motor 120a, an output shaft 111a, a power supply, and an installation apparatus 110a. The motor 120a is disposed in the casing 150a, the output shaft 111a extends in a direction of a first axis 101a, the output shaft 111a is driven by the motor 120a and can drive the operation accessory 200a to swing around the first axis 101a, and the power supply may be a battery pack or an alternating current power supply. The multifunctional power tool 100a further includes a transmission assembly 140a configured to convert rotation of the motor 120a into swings of the output shaft 111a, and the transmission assembly 140a is connected to the motor 120a and the output shaft 111a. The installation apparatus 110a is connected to the output shaft 111a, and the installation apparatus 110a is configured to be detachably connected to the operation accessory 200a so that the operation accessory 200a is installed and driven to swing around the first axis 101a through the installation apparatus 110a.

The operation accessory 200a may be a cutting circular saw blade or cutting straight saw blade provided with sawteeth, or a saw blade such as a sanding disc and a polishing disc with sanding surfaces. The operation accessory 200a has at least a first installation hole 211a and a second installation hole 212a that fit with the installation apparatus 110a so that the operation accessory 200a can be detachably installed.

Referring to FIG. 21, the casing 150a includes a front end casing and a holding casing. The output shaft 111a for output is installed in the front end casing 151a, and the holding casing 152a is held by a user. The motor 120a and the transmission assembly 140a are disposed in the casing 150a, and the motor 120a is disposed in the holding casing 152a. The power supply is supported by the casing 150a and connected to the motor 120a. The transmission assembly 140a includes a transmission bearing 141a and a shift fork 142a. The shift fork 142a has a swing link and a clamping portion disposed at an end of the swing link. The swing link is connected to the transmission bearing 141a. The clamping portion clamps the output shaft 111a to fix the output shaft 111a. The installation apparatus 110a is connected to the output shaft 111a and configured to fix the operation accessory 200a so that the motor 120a drives the transmission assembly 140a to swing, and the shift fork 142a drives the output shaft 111a to swing. In this manner, the shift fork 142a, the output shaft 111a, the installation apparatus 110a, and the operation accessory 200a form a whole that swings around the first axis 101a, and the operation accessory 200a performs cutting and polishing.

The multifunctional power tool 100a further includes an energy supply apparatus installed on or supported by the casing 150a and a control unit that controls the operation of the multifunctional power tool 100a. The control unit generally adopts a circuit board assembly and is connected to the motor 120a to control the operation of the multifunctional power tool 100a.

In an example, the motor 120a includes a motor shaft 121a for output, the motor shaft 121a extends along a second axis 102a, the transmission assembly 140a further includes a transmission shaft 143a and a supporting bearing 144a, and the transmission shaft 143a extends along the second axis 102a and is drivingly connected to the motor shaft 121a to be driven to rotate by the motor shaft 121a. An end of the transmission shaft 143a is supported by the supporting bearing 144a, and the transmission shaft 143a is connected to the transmission bearing 141a. The transmission shaft 143a has at least a shaft section that is partially non-centrosymmetric relative to the second axis 102a, the transmission bearing 141a is sleeved on the non-centrosymmetric section, and the transmission bearing 141a is eccentrically arranged relative to the second axis 102a and has an eccentricity. The shift fork 142a is connected to the transmission bearing 141a and driven by the transmission bearing 141a to swing around the first axis 101a, and the shift fork 142a clamps the output shaft 111a through its clamping portion, thereby driving the output shaft 111a to swing around the first axis 101a.

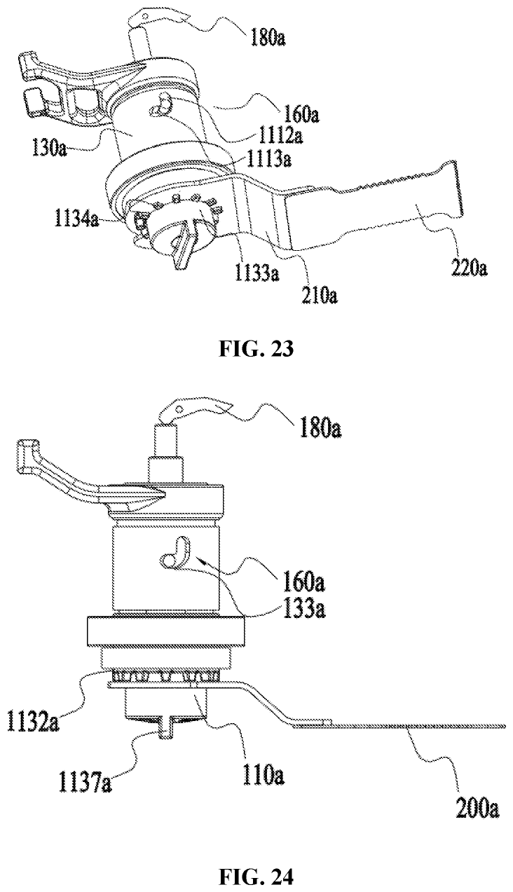

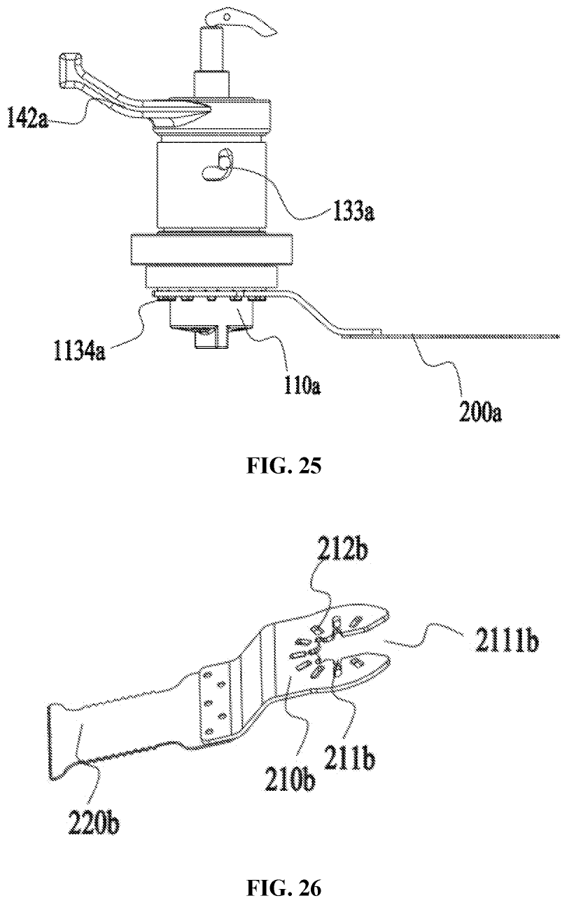

Referring to FIGS. 22 to 25, the multifunctional power tool in this example is shown. The installation apparatus 110a includes a first installation piece 1131a, a first clamping portion 1133a, and a second installation piece 1132a. The operation accessory 200a is installed between the first installation piece 1131a and the second installation piece 1132a. The second installation piece 1132a is formed with a second clamping portion 1134a that can fit with the first clamping portion 1133a to clamp the operation accessory 200a. The installation apparatus 110a has an operation state and an installation state. Referring to FIGS. 22 and 24, when being in the operation state, the installation apparatus 110a can drive the operation accessory 200a to move together with the output shaft. Referring to FIG. 23, when being in the installation state, the installation apparatus 110a allows the operation accessory 200a to be installed to the installation apparatus 110a and allows the operation accessory 200a to be disassembled from the installation apparatus 110a. In this manner, the installation apparatus 110a is operated so that the operation accessory 200a can be quickly installed to the multifunctional power tool 100a or quickly disassembled from the multifunctional power tool 100a.

The first installation piece 1131a is an apparatus for the user to operate to trigger the operation state of the installation apparatus, and the first installation piece is disposed at a lower end of the output shaft 111a. Here, the operation accessory 200a is also disposed at the lower end of the output shaft 111a. Therefore, an apparatus for the user to operate to trigger the installation apparatus to lock the operation accessory is an accessory disposed at a position where the operation accessory is installed, which is convenient for the user to operate to install the operation accessory 200a. The first installation piece 1131a further includes an operation portion 1137a for the user to operate the first installation piece 1131a to drive the first installation piece 1131a to rotate around the first axis 101a, thereby triggering the installation apparatus 110a to enter the operation state from the installation state so as to install and lock the operation accessory 200a.

The multifunctional power tool 100a further includes a retention mechanism 160a which has a retention state in which the retention mechanism 160 can provide a retaining force that keeps the installation apparatus 110a in the installation state. The retention mechanism 160a includes a guide rail 1111a and a movable piece 133 configured to slide in the guide rail 1111a. The multifunctional power tool 100a further includes an inner shaft 130a that can rotate relative to the output shaft 111a and is fixedly connected to the first installation piece 1131a. The first installation piece 1131a is operated to rotate around the first axis 101a to trigger the retention mechanism 160a to release a retention effect on the installation apparatus 110a. Referring to FIGS. 8 and 9, the multifunctional power tool 100a further includes an energy storage element 112a storing a driving force for driving the installation apparatus 110a to have a tendency to move toward the operation state. In the case where the installation apparatus 110a is in the installation state and receives a rotation force applied by the user, the inner shaft 130a rotates relative to the output shaft 111a to trigger the energy storage element 112a to exert the driving force to drive the installation apparatus 110a to move to the operation state. The multifunctional power tool 100a further includes an unlocking piece 180a connected to the inner shaft 130a for the user to operate to drive the inner shaft 130a to be displaced so that the movable piece 133 slides from a second retention position to a first retention position. Linkage principles of the retention mechanism 160a and the energy storage element 112a with the installation apparatus 110a are the same as those in the preceding example, which are not described in detail herein.

Referring to FIG. 23, the operation accessory 200a includes a connection portion 210a and an operation portion 220a. The operation portion 220a is used for output of an operation saw blade. The connection portion 210a is connected to the installation apparatus and provided with the first installation hole 211a and the second installation hole 212a. For example, the operation accessory 200a is a saw blade. The operation portion 220a is provided with sawteeth to cut an object, and the connection portion 210a is provided with the first installation hole 211a and the second installation hole 212a. The first installation hole 211a is disposed in the middle of the connection portion 210a, and the second installation hole 212a is disposed on a peripheral side of the first installation hole 211a. Multiple second installation holes 212a are provided and arranged around the first installation hole 211a. A dimension of the first installation hole 211a is configured to be greater than a dimension of a cross-section of the inner shaft 130a so that the inner shaft 130a can penetrate the first installation hole 211a. The dimension of the first installation hole 211a is configured to be less than a dimension of a cross-section of the first installation piece 1131a so that when the operation accessory 200a is installed between the first installation piece 1131a and the second installation piece 1132a, the operation accessory 200a will not be disengaged from the first installation piece 1131a in the direction of the first axis 101a through the first installation hole 211a.

The first installation piece 1131a is configured to be a knob for the user to operate, the operation portion 1137a is a protrusion for the user to rotate, and the first installation piece 1131a is fixedly connected to the inner shaft 130a. The user rotates the first installation piece 1131a to drive the inner shaft 130a to rotate, and the movable piece 133a connected to the inner shaft 130a is driven to slide in the guide rail 1111a to move between a first guide rail 1112a and a second guide rail 1113a in the guide rail 1111a so that the inner shaft 130a moves in an axial direction of the first axis 101a. In this manner, the first installation piece 1131a fits with the second installation piece 1132a and thus the operation accessory 200a can be unlocked and locked.

The second clamping portion 1134a of the second installation piece 1132a fits with the second installation holes 212a in position and dimension so that the second clamping portion 1134a can be placed into the second installation holes 212a and pass through the operation accessory 200a through the second installation holes 212a in the axial direction of the first axis 101a, and thus in the operation state, the second clamping portion 1134a limits the displacement of the operation accessory 200a in a radial direction of the first axis 101a. The first clamping portion 1133a is formed on a bottom surface of the first installation piece 1131a facing the second installation piece 1132a. In this example, the second clamping portion 1134a is a plane. The first installation piece 1131a is acted by the energy storage apparatus in the operation state and fits with the second installation piece 1132a to clamp the operation accessory 200a in the axial direction of the first axis 101a, and the first clamping portion 1133a supports the operation accessory 200a in the radial direction. The first clamping portion 1133a fits with the second clamping portion 1134a so that in the operation state, the operation accessory 200a is fixedly installed to the installation apparatus 110a.

In an example, referring to FIG. 26, a connection portion 210b is provided with an opening, that is, a first installation hole 211b extends to an edge of the connection portion 210b of the operation accessory, and an opening 2111b is formed at the edge of the connection portion 210b. When installing the operation accessory to the installation apparatus, the user inserts the opening 2111b toward the inner shaft and aligns the second installation hole with the second clamping portion in the radial direction so that the connection portion 210b is placed between the first installation piece and the second installation piece. The user twists the first clamping portion to rotate the connection portion 210b from a first position to a second position. The inner shaft rotates and moves relatively upward when acted by the energy storage apparatus, that is, the first installation piece is closer to the second installation piece. The first installation piece drives the operation accessory to move toward the first installation piece, the second clamping portion is inserted into the second installation holes 212b, and the first installation piece fits with the second installation piece to clamp the operation accessory. In this example, the first installation hole 211b may or may not communicate with the second installation holes 212b, which does not constitute a limitation.

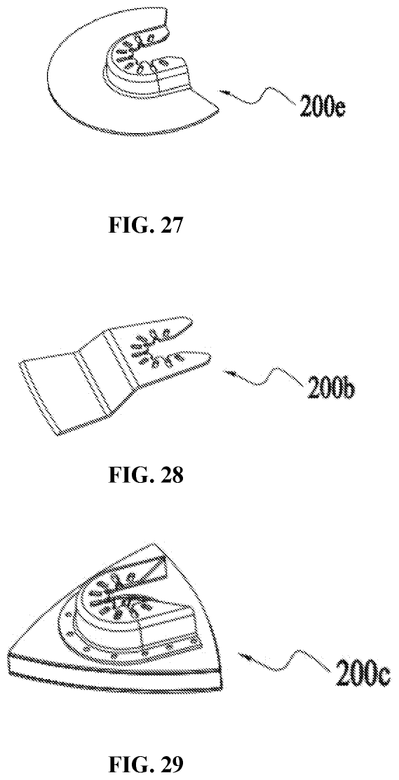

Referring to FIGS. 27 to 29, the operation accessory may also be an accessory such as a shovel saw 200b, a polishing disc 200c, or a grinding disc 200e and has an installation hole fitting with the installation apparatus, which is not described in detail herein.

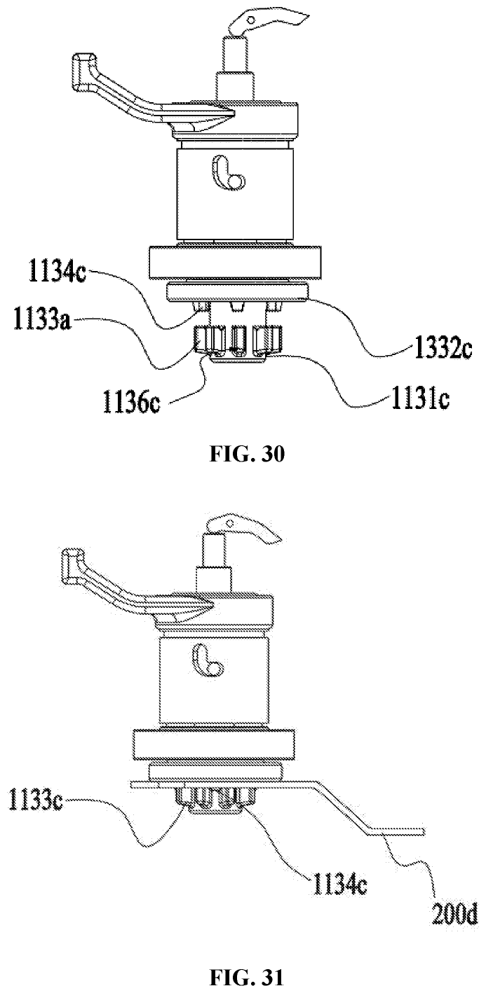

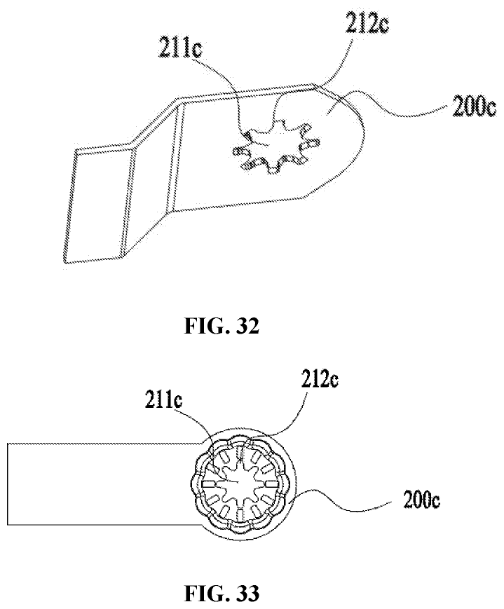

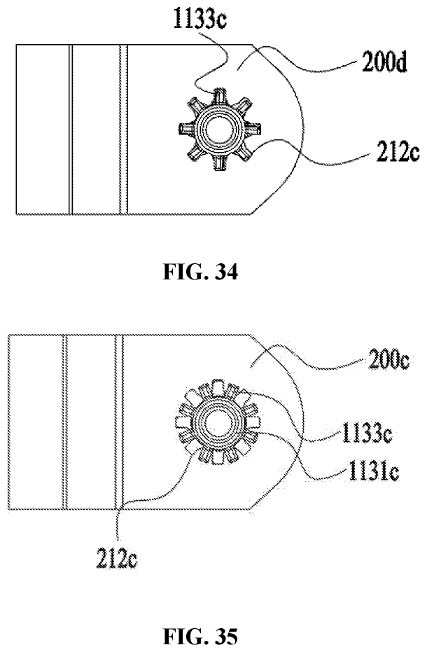

Referring to FIGS. 30 and 31, in an example of the present application, a first installation piece 1131c is connected to an inner shaft and includes a first clamping portion distributed in a circumferential direction around the first axis. Referring to FIGS. 32 and 33, an operation accessory 200c in an example is shown. The operation accessory 200c includes a first installation hole 211c and a second installation hole 212c. The second installation hole 212c communicates with the first installation hole 211c. The first installation piece 1131c is configured to pass through the first installation hole 211c and the second installation hole 212c along the first axis. In an example, the first installation hole 211c is formed in the middle of the connection portion, and the second installation hole 212c surrounds and communicates with the first installation hole 211c. In an example, multiple second installation holes 212c are provided and centrosymmetrically distributed relative to the first installation hole 211c. The first installation piece 1131c includes a first clamping portion 1133c formed on a side of the first installation piece 1131c and corresponding to the second installation hole 212c in position and dimension. Referring to FIG. 34, when the first installation piece 1131c is at a first position, the first installation piece 1131c is configured to pass through the first installation hole 211c and the second installation hole 212c along the first axis, and the operation accessory 200c passes through the first installation piece 1131c and is placed between the first installation piece 1131c and a second installation piece 1132c. Referring to FIG. 35, the user rotates the first installation piece 1131c, the first installation piece 1131c is operated to rotate around the first axis to a second position, and the first clamping portion 1133c and the second installation hole 212c are staggered in a direction of the first axis. In this manner, the first clamping portion 1133c supports and clamps the operation accessory 200d in the axial direction of the first axis, and a second clamping portion 1134c of the second installation piece 1132c fits with the second installation hole 212c in position and dimension so that the second clamping portion 1134c can also be inserted into the second installation hole 212c in the direction of the first axis, and thus the second installation piece 1132c fits with the first installation piece 1131c to clamp the operation accessory 200d.

The first clamping portion 1133c surrounds centrosymmetrically the first installation piece 1131c around the first axis and is formed with an operation portion 1136c. The user controls rotation of the first installation piece 1131c by holding the operating portion 1136c, that is, the user controls the rotation of the first installation piece 1131c by holding multiple first clamping portions 1133c. In this manner, the installation apparatus is triggered to lock the operation accessory.

It is to be understood that the installation apparatus in this example may also be configured to install the operation accessory provided with the opening. Therefore, the installation apparatus can be adapted to install operation accessories of different interface types, which improves the compatibility of the installation apparatus with operation accessories.

In this example, the operation accessory 200d may further include a third installation hole 213c configured to be connected to the second clamping portion 1134c. In this case, the second clamping portion 1134c is inserted into the third installation hole 213c in the operation state, the second installation hole 212c is only used for the first clamping portion 1133c to pass through when the operation accessory is installed, and in the operation state, the first clamping portion 1133c and the third installation hole 213c are staggered in the axial direction of the first axis. In this manner, the first clamping portion 1133c supports the operation accessory, and the first clamping portion 1133c fits with the second clamping portion 1134c to lock the operation accessory 200d.

What is claimed is:

1. A power tool, comprising:
an output shaft capable of rotating or swinging around a first axis;
an installation apparatus configured to install an operation accessory to the power tool, wherein the installation apparatus has an operation state and an installation state, the installation apparatus is capable of driving the operation accessory to move together with the output shaft when the installation apparatus is in the operation state, and the installation apparatus allows the operation accessory to be installed to the installation apparatus and allows the operation accessory to be disassembled from the installation apparatus when the installation apparatus is in the installation state;
an inner shaft at least partially disposed in the output shaft and connected to the installation apparatus; and
a retention mechanism capable of at least providing a retaining force that keeps the installation apparatus in a state in which the operation accessory is allowed to be disassembled and installed;
wherein the retention mechanism comprises a movable piece connected to the inner shaft, the output shaft is formed with a guide rail that guides the movable piece to move, the movable piece is capable of moving along the guide rail to a first retention position and a second retention position, and, in a case where the installation apparatus is in the installation state and receives a rotation force applied by the operation accessory, the rotation force causes the movable piece to move from the second retention position to the first retention position so that the installation apparatus is switched from the installation state to the operation state.

2. The power tool of claim 1, wherein the installation apparatus comprises a first installation piece and a second installation piece adapted to fit with each other to fix the operation accessory and, in a process of the installation apparatus being switched from the operation state to the installation state, the first installation piece and the second installation piece rotate relative to each other in a circumferential direction around the first axis.

3. The power tool of claim 2, wherein, when the movable piece moves from the first retention position to the second retention position, the first installation piece rotates in a first rotation direction relative to the second installation piece and a distance between the first installation piece and the second installation piece increases, and, when the movable piece moves from the second retention position to the first retention position, the first installation piece rotates in a second rotation direction relative to the second installation piece and the distance between the first installation piece and the second installation piece decreases.

4. The power tool of claim 3, comprising an operation piece connected to a top end of the inner shaft and operable to drive the inner shaft to be displaced so that the movable piece slides from the first retention position to the second retention position.

5. The power tool of claim 1, wherein the guide rail comprises a first guide rail and a second guide rail that are smoothly connected and, when the movable piece slides from the first retention position to the second retention position, the movable piece slides from the first guide rail to the second guide rail and provides the retaining force that keeps the installation apparatus in the installation state in the second guide rail.

6. The power tool of claim 5, wherein a height of a sliding trajectory of the movable piece in a vertical direction of the guide rail is less than or equal to a height of the guide rail in the vertical direction.

7. The power tool of claim 5, wherein, when the movable piece moves from the first retention position to the second retention position, the movable piece rotates circumferentially relative to an axis of the inner shaft by 1° to 45°.

8. A power tool, comprising:
an output shaft configured to output power;
an installation apparatus configured to install an operation accessory to the power tool, wherein the installation apparatus has an operation state and an installation state, the installation apparatus is capable of driving the operation accessory to move together with the output shaft when the installation apparatus is in the operation state, and the installation apparatus allows the operation accessory to be installed to the installation apparatus and allows the operation accessory to be disassembled from the installation apparatus when the installation apparatus is in the installation state; and
an energy storage element storing a driving force for driving the installation apparatus to have a tendency to move toward the operation state;
wherein, when the installation apparatus is in the installation state and receives a rotation force applied by the operation accessory, the energy storage element exerts the driving force to drive the installation apparatus to move to the operation state.

9. The power tool of claim 8, wherein the installation apparatus further comprises an inner shaft indirectly connected to the output shaft and the inner shaft rotates relative to the output shaft to trigger the energy storage element to exert the driving force to drive the installation apparatus to move to the operation state.

10. The power tool of claim 9, comprising a retention mechanism, wherein the retention mechanism comprises a movable piece connected to the inner shaft and a guide rail formed on the output shaft and the movable piece is placed in the guide rail and capable of sliding in the guide rail so that the inner shaft and the output shaft are indirectly connected and capable of rotating relative to each other.

11. The power tool of claim 10, wherein the output shaft is capable of rotating or swinging around a first axis, the output shaft is formed with a receiving cavity around the inner shaft, and the movable piece extends in a direction perpendicular to the first axis and is inserted into the guide rail in the direction perpendicular to the first axis.

12. The power tool of claim 11, wherein the energy storage element is a spring disposed in the receiving cavity and the spring is sleeved on the inner shaft and biases against the inner shaft to produce the driving force.

13. A power tool, comprising:
an output shaft capable of rotating or swinging around a first axis;
an installation apparatus configured to install an operation accessory to the power tool, wherein the installation apparatus has an operation state and an installation state, the installation apparatus is capable of driving the operation accessory to move together with the output shaft when the installation apparatus is in the operation state, and the installation apparatus allows the operation accessory to be installed to the installation apparatus and allows the operation accessory to be disassembled from the installation apparatus when the installation apparatus is in the installation state; and
a retention mechanism capable of at least providing a retaining force that keeps the installation apparatus in the installation state; and
wherein, when the installation apparatus is in the installation state and receives a rotation force applied by the operation accessory, the rotation force triggers the retention mechanism to release a retention effect on the installation apparatus and the installation apparatus is switched from the installation state to the operation state.

14. The power tool of claim 13, wherein the power tool further comprises an inner shaft rotatable relative to the output shaft, the inner shaft is connected to the installation apparatus, and the installation apparatus transmits the received rotation force to the inner shaft so that the inner shaft rotates relative to the output shaft to trigger the retention mechanism to release the retention effect on the installation apparatus.

15. The power tool of claim 14, wherein the output shaft is capable of driving the operation accessory to rotate or swing around the first axis in a first rotation direction when the installation apparatus is in the operation state and the power tool further comprises a limiting mechanism that prevents the output shaft from rotating or swinging around the first axis in a second rotation direction opposite to the first rotation direction.

16. The power tool of claim 15, wherein the limiting mechanism comprises a one-way bearing connected to the output shaft.

17. The power tool of claim 14, further comprising a limiting mechanism capable of being switched between a state in which the output shaft is allowed to rotate and a state in which the output shaft is prevented from rotating.

18. The power tool of claim 13, wherein the operation accessory comprises a central hole configured to fit with the installation apparatus to achieve installation, a hole wall of the central hole is formed with a groove recessed in a direction farther from the first axis, the installation apparatus comprises a first installation piece formed with a first clamping portion and a second installation piece formed with a second clamping portion capable of fitting with the first clamping portion to clamp the operation accessory, the first installation piece is capable of moving to a first position and a second position relative to the second installation piece, the first clamping portion is disengaged from the second clamping portion in a direction of the first axis when the first installation piece moves to the first position, and both the first clamping portion and the second clamping portion are inserted into the groove when the first installation piece moves to the second position.

19. The power tool of claim 18, wherein, when the first installation piece is switched from the second position to the first position, a distance between the first clamping portion and the second clamping portion that are inserted into the same groove in a circumferential direction around the first axis increases.

20. The power tool of claim 18, wherein the first clamping portion has a first clamping surface in contact with a groove wall of the groove, the second clamping portion has a second clamping surface in contact with the groove wall of the groove, the first clamping portion and the second clamping portion that are inserted into the same groove are defined as a clamping assembly, and a minimum dimension between the first clamping surface and the second clamping surface in a circumferential direction around the first axis is greater than a minimum dimension of the groove in the circumferential direction around the first axis when the first clamping portion is at the first position.
